(19) United States
(12) Patent Application Publication
(10) Pub. No.: US 2023/0319332 A1
(43) Pub. Date: Oct. 5, 2023

(54) METHODS AND APPARATUS TO ANALYZE AND ADJUST AGE DEMOGRAPHIC INFORMATION

(71) Applicant: The Nielsen Company (US), LLC, New York, NY (US)

(72) Inventors: Jonathan Sullivan, Natick, MA (US); ChoongKoo Lee, Schaumburg, IL (US)

(21) Appl. No.: 17/711,761

(22) Filed: Apr. 1, 2022

(51) Int. Cl. H04N 21/258; H04N 21/25; G06N 20/20

(52) U.S. Cl. CPC H04N 21/25883; H04N 21/251; G06N 20/20

(57) ABSTRACT

Example methods, apparatus, systems, and articles of manufacture to facilitate analysis and adjustment of demographic information for monitored audience members are disclosed. Disclosed example methods include receiving a data set including media exposure data and associated data from at least one of a panelist database and a user account database. Disclosed example methods include measuring the data set to determine a probability distribution of user age in the data set according to a first model. Disclosed example methods include comparing the probability distribution of user age to a threshold. Disclosed example methods include adjusting, based on the comparison of the probability distribution of user age to the threshold, the probability distribution to an adjusted probability distribution by replacing the probability distribution with a degenerate distribution. Disclosed example methods include generating audience measurement information based on the data set and the probability distribution and/or the adjusted probability distribution.

### FIELD OF THE DISCLOSURE

This disclosure relates generally to audience measurement, and, more particularly, to methods and apparatus to analyze and adjust demographic information, such as age, of audience members.

### BACKGROUND

Traditionally, audience measurement entities determine compositions of audiences exposed to media by monitoring registered panel members and extrapolating their behavior onto a larger population of interest. That is, an audience measurement entity enrolls people that consent to being monitored into a panel and collects relatively highly accurate demographic information from those panel members via, for example, in-person, telephonic, and/or online interviews. The audience measurement entity then monitors those panel members to determine media exposure information identifying media (e.g., television programs, radio programs, movies, streaming media, online behavior, etc.) exposed to those panel members. By combining the media exposure information with the demographic information for the panel members, and by extrapolating the result to the larger population of interest, the audience measurement entity can determine detailed audience measurement information such as media ratings, audience composition, reach, etc. This audience measurement information can be used by advertisers to, for example, place advertisements with specific media to target audiences of specific demographic compositions.

More recent techniques employed by audience measurement entities monitor exposure to Internet accessible media or, more generally, online media. These techniques expand the available set of monitored individuals to a sample population that may or may not include registered panel members. In some such techniques, demographic information for these monitored individuals can be obtained from one or more database proprietors (e.g., social network sites, multi-service sites, online retailer sites, credit services, etc.) with which the individuals subscribe to receive one or more online services. However, the demographic information available from these database proprietor(s) may be self-reported and, thus, unreliable or less reliable than the demographic information typically obtained for panel members registered by an audience measurement entity.

### BRIEF DESCRIPTION OF THE DRAWINGS

FIG. 1 illustrates an example initial age scatter plot of baseline self-reported ages from a social media website prior to adjustment versus highly reliable panel reference ages.

FIG. 2 shows an example audience measurement entity age category table.

FIG. 3 shows an example terminal node table showing tree model predictions for multiple leaf nodes of a classification tree.

FIG. 4 illustrates an example system including client devices that report audience and/or exposure information for Internet-based media to collection entities to facilitate indication of impression and audience size information for exposure to Internet-based media.

FIG. 5 illustrates an example apparatus that may be used to model, analyze, and/or adjust demographic information of audience members.

FIG. 6 illustrates a more detailed view of an implementation of the example apparatus of FIG. 5 that may be used to model, analyze, and/or adjust demographic information of audience members.

FIG. 7 illustrates further detail regarding an example implementation of the analyzer of the example of FIG. 6.

FIG. 8 illustrates a graph of two example user age distributions.

FIG. 9 depicts an example graph illustrating an example parameter sweep to determine an adjustment threshold.

FIG. 10 is a flow diagram representative of example machine readable instructions that may be executed to implement an example analysis and adjustment process including the example analysis and adjustment apparatus of FIGS. 4-7 and its components.

FIG. 11 is a flow diagram representative of example machine readable instructions that may be executed to implement the example demographic data correction module of FIGS. 5-6.

FIG. 12 is a flow diagram representative of example machine readable instructions that may be executed to implement the example analyzer of FIGS. 6-7.

FIG. 13 is a block diagram of an example processor platform capable of executing the instructions of FIGS. 10-12 to implement the example analysis and adjustment apparatus (and its components) of FIGS. 4-7.

### DETAILED DESCRIPTION

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and other changes may be made without departing from the scope of the subject matter of this disclosure. The following detailed description is, therefore, provided to describe example implementations and not to be taken as limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Techniques for monitoring user access to Internet resources such as web pages, advertisements and/or other content have evolved significantly over the years. Traditionally, audience measurement entities (AMEs, also referred to herein as “ratings entities”) determine demographic reach for advertising and media programming based on registered panel members. That is, an audience measurement entity enrolls people that consent to being monitored into a panel. During enrollment, the audience measurement entity receives demographic information from the enrolling people so that subsequent correlations may be made between advertisement/media exposure to those panelists and different demographic markets.

Audience measurement entities provide insight to online advertisers regarding a number and type of people that are served or provided advertisements. For example, The Nielsen Company (US)'s Digital Ad Ratings (DAR) provide insight into how well specific advertisers can target users, along with information as to the demographic distribution of visitors for particular media (e.g., a web site, a page, etc.). For example, an audience measurement entity can collect demographic information (e.g., gender, age, etc.) from users who agree to be part of a panel. In some such examples, when a panelist accesses metered media, user identifying information is transmitted to the audience measurement entity. The audience measurement entity may then aggregate demographic information for the users who accessed the media to estimate a demographic distribution of users who access the media.

In addition to traditional techniques in which audience measurement entities rely solely on their own panel member data to collect demographics-based audience measurement, certain examples disclosed herein enable an audience measurement entity to share demographic information with other entities that operate based on user registration models. As used herein, a user registration model is a model in which users subscribe to services of those entities by creating an account and providing demographic-related information about themselves (e.g., age, gender, sex, etc.). Sharing of demographic information associated with registered users of database proprietors enables an audience measurement entity to extend or supplement their panel data with substantially reliable demographics information from external sources (e.g., database proprietors), thus extending the coverage, accuracy, and/or completeness of their demographics-based audience measurements. Such access also enables the audience measurement entity to monitor persons who would not otherwise have joined an audience measurement panel. Any entity having a database identifying demographics of a set of individuals may cooperate with the audience measurement entity. Such entities may be referred to as “database proprietors” and include entities such as Facebook, Google, Yahoo!, MSN, Twitter, Apple iTunes, Experian, etc.

In view of the foregoing, an audience measurement company would like to leverage the existing databases of database proprietors to collect more extensive Internet usage and demographic data. However, the audience measurement entity is faced with several problems in accomplishing this end. For example, data in these databases may be inaccurate (e.g., users may lie about their age, etc.). Additionally, privacy concerns may limit how such database information can be used without consent of the subscribers, panelists, and/or proprietors of content, for example.

In some examples, the audience measurement entity may partner with a data proprietor (e.g., a social network host) to meter online advertising campaigns. For example, in some examples, when the user accesses the metered media, a tag including user identifying information may be transmitted to the data proprietor. The data proprietor may then map the user identifying information to demographic information provided by the user. For example, when registering with a social network host, a user may provide their gender and their age. The data proprietor may then provide aggregated demographic information for the media to the audience measurement entity. However, in some instances, users who sign-up with the data proprietor may not provide accurate information. For example, a user may lie about his or her age.

Example methods, apparatus, systems, and/or articles of manufacture disclosed herein may be used to analyze and adjust demographic information of audience members (e.g., online audience members exposed to web-based and/or other Internet-based services, content, etc. For online audience measurement processes, the collected demographic information may be used to identify different demographic markets to which online content exposures are attributable.

However, as mentioned above, a problem facing online audience measurement processes is that the demographic information provided by registered users to online data proprietors is not necessarily veridical (e.g., accurate). Example approaches to online measurement that leverage account registrations at such online database proprietors to determine demographic attributes of an audience may lead to inaccurate demographic exposure results if they rely on self-reporting of personal/demographic information by the registered users during account registration at the database proprietor site.

There may be numerous reasons for why users report erroneous or inaccurate demographic information when registering for database proprietor services. The self-reporting registration processes used to collect the demographic information at the database proprietor sites (e.g., social media sites) does not facilitate determining the veracity of the self-reported demographic information.

Examples disclosed herein overcome inaccuracies often found in self-reported demographic information found in the data of database proprietors (e.g., social media sites) by analyzing how those self-reported demographics from one data source (e.g., online registered-user accounts maintained by database proprietors) relate to reference demographic information from a verified panel of users (e.g., in-home or telephonic interviews conducted by the audience measurement entity as part of a panel recruitment process). In examples disclosed herein, an audience measurement entity (AME) collects reference demographic information for a panel of users (e.g., panelists) using highly reliable techniques (e.g., employees or agents of the AME telephoning and/or visiting panelist homes and interviewing panelists) to collect accurate information. With cooperation by the database proprietors, the AME uses the collected monitoring data to link the panelist reference demographic information maintained by the AME to the self-reported demographic information maintained by the database proprietors on a per-person basis and to model the relationships between the highly accurate reference data collected by the AME and the self-report demographic information collected by the database proprietor (e.g., the social media site) to form a basis for adjusting or reassigning self-reported demographic information of other users of the database proprietor that are not in the panel of the AME. The accuracy of self-reported demographic information can be improved when demographic-based online media-impression measurements are compiled for non-panelist users of the database proprietor(s).

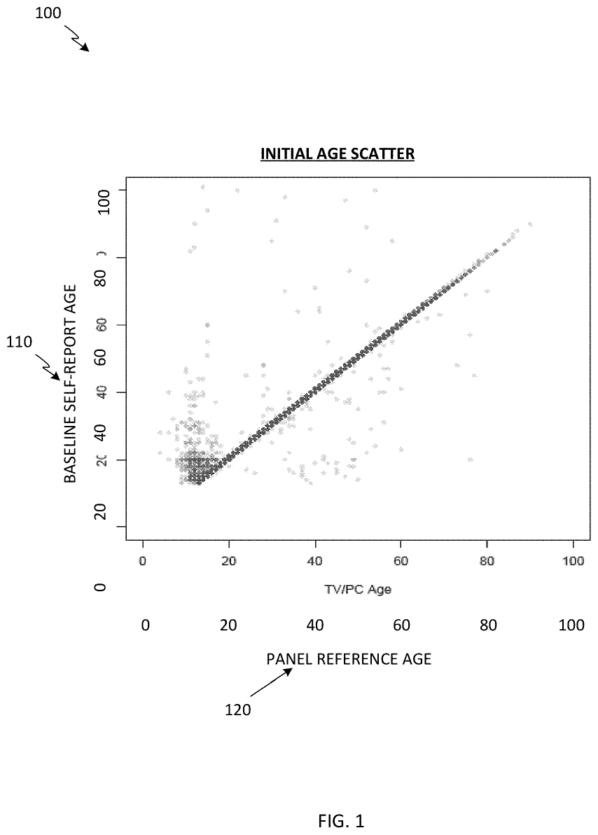

For example, a scatterplot 100 of baseline self-reported ages taken from a database of a database proprietor prior to adjustment versus highly reliable panel reference ages is depicted in FIG. 1. The scatterplot 100 shows a clearly non-linear skew in error distribution between self-reported 110 and confirmed panel 120 ages. This skew is in violation of a regression assumption of normally distributed residuals (e.g., systematic variance) and results in limited success when analyzing and adjusting self-reported demographic information using known linear approaches (e.g., regression, discriminant analysis). For example, such known linear approaches applied to self-reported age 110 can introduce inaccurate bias or shift in demographics resulting in inaccurate conclusions. Examples disclosed herein correct such skew by analyzing and updating inaccuracies in self-reported age.

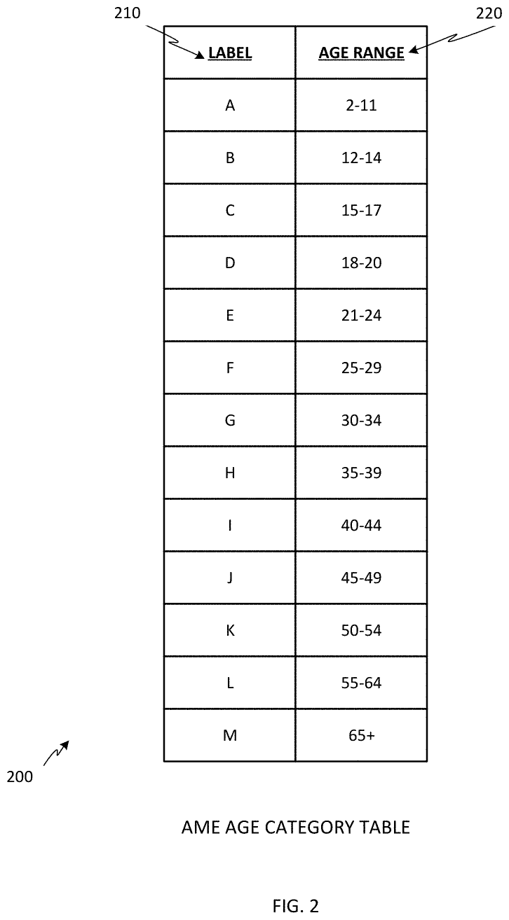

Using a decision tree-based approach, in which users are recursively grouped according to one or more aspects of demographic data, demographic data, such as user age, can be categorized according to a probability distribution (e.g., a probability density function or PDF). FIG. 2 shows an example AME age category table 200 used in conjunction with terminal or end nodes of a decision tree to categorize user age. The example AME age category table 200 includes a breakdown of age groups established by an AME for its panel members. As shown in the example table 200, a label or category 210 is assigned to each age range 220. An example advantage of predicting for groups of ages rather than exact ages is that it is relatively simpler to predict accurately for a bigger target (e.g., a larger quantity of people). The example AME age category table 200 can similarly be used to categorize ages for users with self-reported demographics. As discussed above, such ages can be false or inaccurately reported, however.

A decision tree is a decision support tool that uses a tree-like graph or model to organize information, such as user age. In certain examples, user age data can be processed to group available users according to their probability of being in a certain age group or category, such as the age ranges 220 shown in the example of FIG. 2.

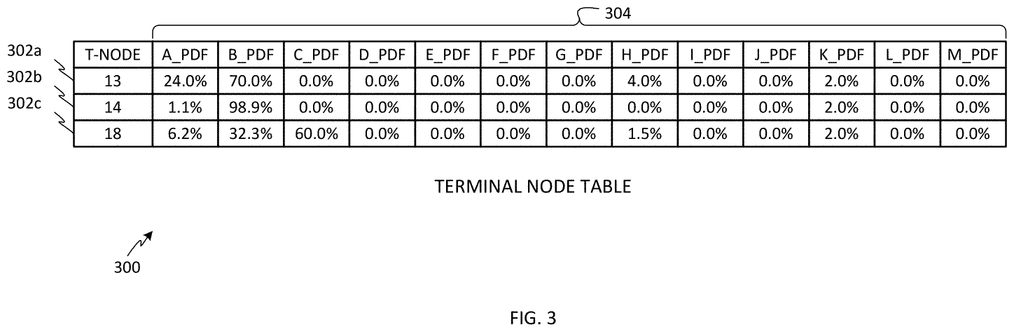

FIG. 3 shows an example terminal node table 300 showing tree model predictions for multiple leaf nodes of a set of output results, such as user age ranges or values. The example terminal node table 300 shows three leaf node records 302a-c for three leaf nodes generated using age-related information for a set of monitored users. Although only three leaf node records 302a-c are shown in FIG. 3, the example terminal node table 300 includes a leaf node record for each AME age falling into the AME age categories or buckets shown in the example AME age category table 200.

In the illustrated example, an output result set is generated by running a training model to predict the AME age bucket (e.g., the age categories of the AME age category table 200 of FIG. 2) for each leaf 302a-c in the example table 300. In the illustrated example of FIG. 3, each terminal node (e.g., each of the leaf node records 302a-c) includes or is associated with a probability density function (PDF) characterizing the true distribution of AME ages among a group of users predicted across the age buckets (e.g., the A_PDF through M_PDF columns 304 in the terminal node table 300). In certain examples, an age adjustment can be determined and used to multiply age bucket coefficients (e.g., which can be normalized, for example) to determine an exact number of users in each age bucket (e.g., using a convolution process. In the illustrated example of FIG. 3, the collection of PDF coefficients for all terminal nodes are noted in the A_PDF through M_PDF columns 304 to form a coefficient matrix. Further examples regarding decision tree distribution, analysis, and adjustment of demographic information are disclosed in U.S. Pat. No. 9,092,797 to Perez et al., commonly owned with the present patent by The Nielsen Company (US), LLC, and herein incorporated by reference in its entirety.

Some disclosed example methods, apparatus, systems, and articles of manufacture facilitate analysis and adjustment of demographic information for monitored audience members.

Some disclosed example methods involve receiving, using a particularly programmed processor, a data set including media exposure data and associated data from at least one of a panelist database and a user account database. Some disclosed example methods involve measuring, using the processor, the data set to determine a probability distribution of user age in the data set according to a first model. Some disclosed example methods involve comparing, using the processor, the probability distribution of user age to a threshold. Some disclosed example methods involve adjusting, using the processor based on the comparison of the probability distribution of user age to the threshold, the probability distribution to an adjusted probability distribution by replacing the probability distribution with a degenerate distribution. Some disclosed example methods involve generating, using the processor, audience measurement information based on the data set and at least one of the probability distribution or the adjusted probability distribution.

Some disclosed example apparatus include a data interface to receive data from a panelist database and a user account database and merge the data into a combined panelist-user data set. Some disclosed example apparatus include a demographic data correction module to analyze and adjust the panelist-user data set to correct user demographic data in the panelist-user data set, the user demographic data correlated with media exposure data to provide audience measurement information. In some disclosed example apparatus, the demographic data correction module includes a measurement module to measure the panelist-user data set to determine a probability distribution of user age in the data set according to a first model. In some disclosed example apparatus, the demographic data correction module includes a comparator to compare the probability distribution of user age to a threshold. In some disclosed example apparatus, the demographic data correction module includes a distributor to adjust, based on the comparison of the probability distribution of user age to the threshold, the probability distribution to an adjusted probability distribution by replacing the probability distribution with a degenerate distribution. In some disclosed example apparatus, the demographic data correction module includes an output to generate audience measurement information based on the panelist-user data set and at least one of the probability distribution or the adjusted probability distribution.

Some disclosed example computer-readable media include instructions that, when executed, cause a machine to receive a data set including media exposure data and associated data from at least one of a panelist database and a user account database. Some disclosed example computer-readable media include instructions that, when executed, cause a machine to measure the data set to determine a probability distribution of user age in the data set according to a first model. Some disclosed example computer-readable media include instructions that, when executed, cause a machine to compare the probability distribution of user age to a threshold. Some disclosed example computer-readable media include instructions that, when executed, cause a machine to adjust, based on the comparison of the probability distribution of user age to the threshold, the probability distribution to an adjusted probability distribution by replacing the probability distribution with a degenerate distribution. Some disclosed example computer-readable media include instructions that, when executed, cause a machine to generate audience measurement information based on the data set and at least one of the probability distribution or the adjusted probability distribution.

Some disclosed example systems include a means for receiving a data set including media exposure data and associated data from at least one of a panelist database and a user account database. Some disclosed example systems include a means for measuring the data set to determine a probability distribution of user age in the data set according to a first model. Some disclosed example systems include a means for comparing the probability distribution of user age to a threshold. Some disclosed example systems include a means for adjusting, based on the comparison of the probability distribution of user age to the threshold, the probability distribution to an adjusted probability distribution by replacing the probability distribution with a degenerate distribution. Some disclosed example systems include a means for generating audience measurement information based on the data set and at least one of the probability distribution or the adjusted probability distribution.

Audience Measurement Processing

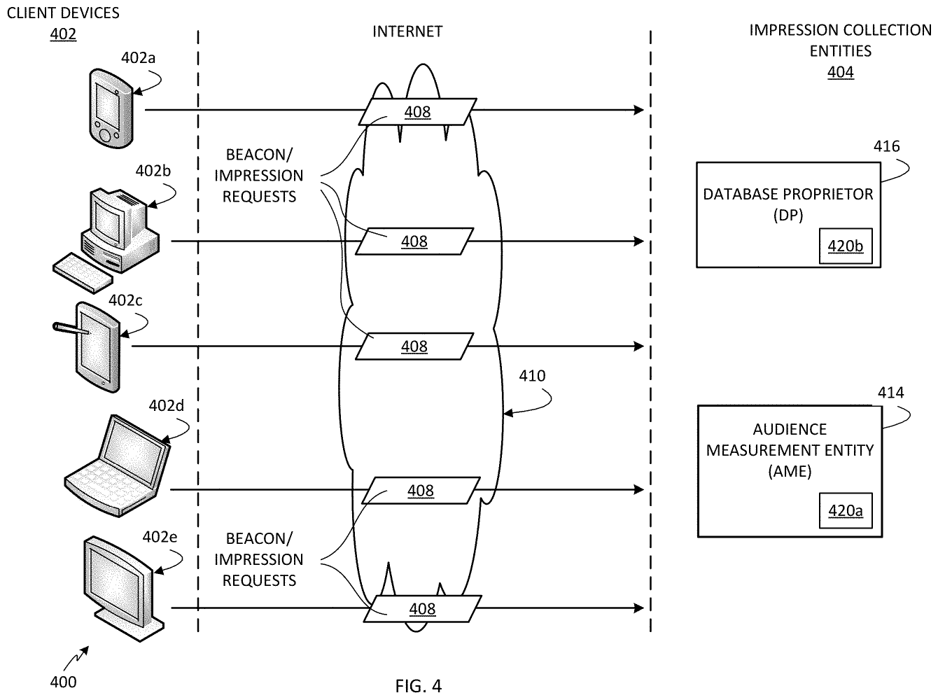

FIG. 4 illustrates example system 400 including client devices 402 (e.g., 402a, 402b, 402c, 402d, 402e) that report audience counts and/or impressions for online (e.g., Internet-based) media to impression collection entities 404 to facilitate determining numbers of impressions and sizes of audiences exposed to different online media. An “impression” generally refers to an instance of an individual's exposure to media (e.g., content, advertising, etc.). As used herein, the term “impression collection entity” refers to any entity that collects impression data, such as audience measurement entities and database proprietors that collect impression data. As used herein, exposures (e.g., visual and/or aural presentations) refer to qualified impressions, or impressions that satisfy a presentation threshold (e.g., at least a certain amount or threshold time period of a video has been presented). Thus, an exposure includes an impression, but an impression may not necessarily be credited as an exposure. For example, an impression corresponding to a presentation of ten seconds of media is not logged as an exposure if a criterion or threshold for exposure includes at least a threshold presentation duration of one minute. Duration refers to an amount of time of that media is presented to a user, which may be credited to an impression (and, if it meets or exceeds the threshold/criterion, an exposure). For example, an impression may correspond to a duration of thirty seconds, one minute, one minute thirty seconds, two minutes, etc.

The client devices 402 of the illustrated example can be implemented by any device capable of accessing media over a network. For example, the client devices 402 can be a computer, a tablet, a mobile device, a smart television, or any other Internet-capable device or appliance. Examples disclosed herein may be used to collect impression information for any type of media. As used herein, “media” refers collectively and/or individually to content and/or advertisement(s). Media may include advertising and/or content delivered via web pages, streaming video, streaming audio, Internet protocol television (IPTV), movies, television, radio and/or any other vehicle for delivering media. In some examples, media includes user-generated media that is, for example, uploaded to media upload sites, such as YouTube, and subsequently downloaded and/or streamed by one or more other client devices for playback. Media may also include advertisements. Advertisements are typically distributed with content (e.g., programming). Traditionally, content is provided at little or no cost to the audience because it is subsidized by advertisers that pay to have their advertisements distributed with the content.

In the illustrated example, the client devices 402 employ web browsers and/or applications (also referred to as “apps”) to access media. Some media includes instructions that cause the client devices 402 to report media monitoring information to one or more of the impression collection entities 404. That is, when a client device 402 of the illustrated example accesses media that is instantiated with (e.g., linked to, embedded with, etc.) one or more monitoring instructions, a web browser and/or other application of the client device 402 executes the one or more instructions (e.g., monitoring instructions, sometimes referred to herein as beacon instruction(s), etc.) in the media. Executing the beacon instruction(s) causes the executing client device 402 to send a beacon or impression request 408 to one or more impression collection entities 404 via, for example, the Internet 410. The beacon request 408 of the illustrated example includes information about the access to the instantiated media at the corresponding client device 402 generating the beacon request. Such beacon requests allow monitoring entities, such as the impression collection entities 404, to collect impressions for different media accessed via the client devices 402. Using beacon/impression requests, the impression collection entities 404 can generate large impression quantities for different media (e.g., different content and/or advertisement campaigns). Example techniques for using beacon instructions and beacon requests to cause devices to collect impressions for different media accessed via client devices are further disclosed in U.S. Pat. No. 6,108,637 to Blumenau and U.S. Pat. No. 8,370,489 to Mainak, et al., which are both incorporated herein by reference in their entirety.

The impression collection entities 404 of the illustrated example include an example audience measurement entity (AME) 414 and an example database proprietor (DP) 416. In the illustrated example of FIG. 4, the AME 414 does not provide the media to the client devices 402 and is a trusted (e.g., neutral) third party (e.g., The Nielsen Company, LLC) for providing accurate media access statistics. In the illustrated example, the database proprietor 416 is one of many database proprietors that operate on the Internet to provide one or more services to users. Such services may include, but are not limited to, email services, social networking services, news media services, cloud storage services, streaming music services, streaming video services, online shopping services, credit monitoring services, etc. Example database proprietors 416 include social network sites (e.g., Facebook, Twitter, MySpace, etc.), multi-service sites (e.g., Yahoo!, Google, etc.), online shopping sites (e.g., Amazon.com, Buy.com, etc.), credit services (e.g., Experian), and/or any other type(s) of web service site(s) that maintain user registration records. In examples disclosed herein, the database proprietor 416 maintains user account records corresponding to users registered for Internet-based services provided by the database proprietors. That is, in exchange for the provision of services, subscribers register with the database proprietor 416. As part of this registration, the subscriber may provide detailed demographic information to the database proprietor 416. The demographic information can include, for example, gender, age, ethnicity, income, home location, education level, occupation, etc. In the illustrated example of FIG. 4, the database proprietor 416 sets a device/user identifier on a subscriber's client device 402 that enables the database proprietor 416 to identify the subscriber in subsequent interactions.

In the illustrated example of FIG. 4, when the database proprietor 416 receives a beacon/impression request 408 from a client device 402, the database proprietor 416 instructs the client device 402 to provide the device/user identifier that had previously been set for the client device 402 by the database proprietor 416. The database proprietor 416 uses the device/user identifier corresponding to the client device 402 to identify demographic information in its user account records corresponding to the subscriber of the client device 402. Using the demographic information, the database proprietor 416 can generate “demographic impressions” by associating demographic information with an impression for the media accessed at the client device 402. Thus, as used herein, a “demographic impression” is defined to be an impression that is associated with one or more characteristic(s) (e.g., a demographic characteristic) of the person(s) exposed to the media via the impression. Through the use of demographic impressions, which associate monitored (e.g., logged) media impressions with demographic information, media exposure can be measured and, by extension, media consumption behaviors can be inferred across different demographic classifications (e.g., groups) of a sample population of individuals.

In the illustrated example, the AME 414 establishes a panel of users who have agreed to provide their demographic information and to have their Internet browsing activities monitored. When an individual joins the AME panel, the person provides detailed information concerning the person's identity and demographics (e.g., gender, age, ethnicity, income, home location, occupation, etc.) to the AME 414. The AME 414 sets a device/user identifier on the person's client device 402 that enables the AME 414 to identify the panelist.

In the illustrated example, when the AME 414 receives a beacon request 408 from a client device 402, the AME 414 instructs the client device 402 to provide the AME 414 with the device/user identifier previously set by the AME 414 for the client device 402. The AME 414 uses the device/user identifier corresponding to the client device 402 to identify demographic information in its user AME panelist records corresponding to the panelist of the client device 402. Using the identified demographic information, the AME 414 can generate demographic impressions by associating demographic information with an audience for the media accessed at the client device 402 as identified in the corresponding beacon request.

In the illustrated example, the database proprietor 416 reports demographic impression data to the AME 414. To preserve the anonymity of its subscribers, the demographic impression data may be anonymous demographic impression data and/or aggregated demographic impression data.

For anonymous demographic impression data, the database proprietor 416 reports user-level demographic impression data (e.g., which is resolvable to individual subscribers), but with any personally identifiable information (PII) removed from or obfuscated (e.g., scrambled, hashed, encrypted, etc.) in the reported demographic impression data. For example, anonymous demographic impression data, if reported by the database proprietor 416 to the AME 414, can include respective demographic impression data for each device 402 from which a beacon request 408 was received, but with any personal identification information (e.g., name, address, social security number, phone number, etc.) removed from or obfuscated in the reported demographic impression data.

For aggregated demographic impression data, individuals are grouped into different demographic classifications, and aggregate demographic data (e.g., which is not resolvable to individual subscribers) for the respective demographic classifications is reported to the AME 414. In some examples, the aggregated data is aggregated demographic impression data. In other examples, the database proprietor 416 is not provided with impression data that is not resolvable to a particular media name (but may instead be given a code or the like that the AME 414 can map to the impression), and the reported aggregated demographic data may, therefore, not be mapped to impressions or may be mapped to the code(s) associated with the impressions.

Aggregate demographic data, if reported by the database proprietor 416 to the AME 414, can include first demographic data aggregated for devices 402 associated with demographic information belonging to a first demographic classification (e.g., a first age group, such as a group that includes ages less than 18 years old), second demographic data for devices 4102 associated with demographic information belonging to a second demographic classification (e.g., a second age group, such as a group that includes ages from 18 years old to 34 years old), etc.

As mentioned above, demographic information available for subscribers of the database proprietor 416 may be unreliable, or less reliable than the demographic information obtained for panel members registered by the AME 414. There are numerous social, psychological and/or online safety reasons why subscribers of the database proprietor 416 may inaccurately represent or even misrepresent their demographic information, such as age, gender, etc. Accordingly, one or more of the AME 414 and/or the database proprietor 416 determine sets of classification probabilities for respective individuals in the sample population for which demographic data is collected. A set of classification probabilities represents a likelihood that an individual in a sample population belongs to respective ones of a set of possible demographic classifications. For example, the set of classification probabilities determined for an individual in a sample population can include a first probability that the individual belongs to a first one of possible demographic classifications (e.g., a first age classification, such as a first age group), a second probability that the individual belongs to a second one of the possible demographic classifications (e.g., a second age classification, such as a second age group), etc. In some examples, the AME 414 and/or the database proprietor 416 determine the sets of classification probabilities for individuals of a sample population by combining, with models, decision trees, etc., the individuals' demographic information with other available behavioral data that can be associated with the individuals to estimate, for each individual, the probabilities that the individual belongs to different possible demographic classifications in a set of possible demographic classifications. Example techniques for reporting demographic data from the database proprietor 416 to the AME 414, and for determining sets of classification probabilities representing likelihoods that individuals of a sample population belong to respective possible demographic classifications in a set of possible demographic classifications, are further disclosed in U.S. Pat. No. 9,092,797 (Perez et al.) and U.S. patent application Ser. No. 14/604,394 (now U.S. Patent Publication No. ____/______) to (Sullivan et al.), which are incorporated herein by reference in their respective entireties.

In the illustrated example of FIG. 4, one or both of the AME 414 and the database proprietor 416 include example audience data generators to determine ratings data from population sample data having incomplete demographic classifications in accordance with the teachings of this disclosure. For example, the AME 414 may include an example audience data generator 420a and/or the database proprietor 416 may include an example audience data generator 420b. As disclosed in further detail below, the audience data generator(s) 420a and/or 420b of the illustrated example process sets of classification probabilities determined by the AME 414 and/or the database proprietor 416 for monitored individuals of a sample population (e.g., corresponding to a population of individuals associated with the devices 402 from which beacon requests 408 were received) to estimate parameters characterizing population attributes (also referred to herein as population attribute parameters) associated with the set of possible demographic classifications.

In some examples, such as when the audience data generator 420b is implemented at the database proprietor 416, the sets of classification probabilities processed by the audience data generator 420b to estimate the population attribute parameters include personal identification information that permits the sets of classification probabilities to be associated with specific individuals. Associating the classification probabilities enables the audience data generator 420b to maintain consistent classifications for individuals over time, and the audience data generator 420b may scrub the PII from the impression information prior to reporting impressions based on the classification probabilities. In some examples, such as when the audience data generator 420a is implemented at the AME 414, the sets of classification probabilities processed by the audience data generator 420a to estimate the population attribute parameters are included in reported, anonymous demographic data and, thus, do not include PII. However, the sets of classification probabilities can still be associated with respective, but unknown, individuals using, for example, anonymous identifiers (e.g., hashed identifiers, scrambled identifiers, encrypted identifiers, etc.) included in the anonymous demographic data.

In some examples, such as when the audience data generator 420a is implemented at the AME 414, the sets of classification probabilities processed by the audience data generator 420a to estimate the population attribute parameters are included in reported, aggregate demographic impression data and, thus, do not include personal identification and are not associated with respective individuals but, instead, are associated with respective aggregated groups of individuals. For example, the sets of classification probabilities included in the aggregate demographic impression data may include a first set of classification probabilities representing likelihoods that a first aggregated group of individuals belongs to respective possible demographic classifications in a set of possible demographic classifications, a second set of classification probabilities representing likelihoods that a second aggregated group of individuals belongs to the respective possible demographic classifications in the set of possible demographic classifications, etc.

Using the estimated population attribute parameters, the audience data generator(s) 420a and/or 420b of the illustrated example determine ratings data for media. For example, the audience data generator(s) 420a and/or 420b can process the estimated population attribute parameters to further estimate numbers of individuals across different demographic classifications who were exposed to given media, numbers of media impressions across different demographic classifications for the given media, accuracy metrics for the estimate number of individuals and/or numbers of media impressions, etc.

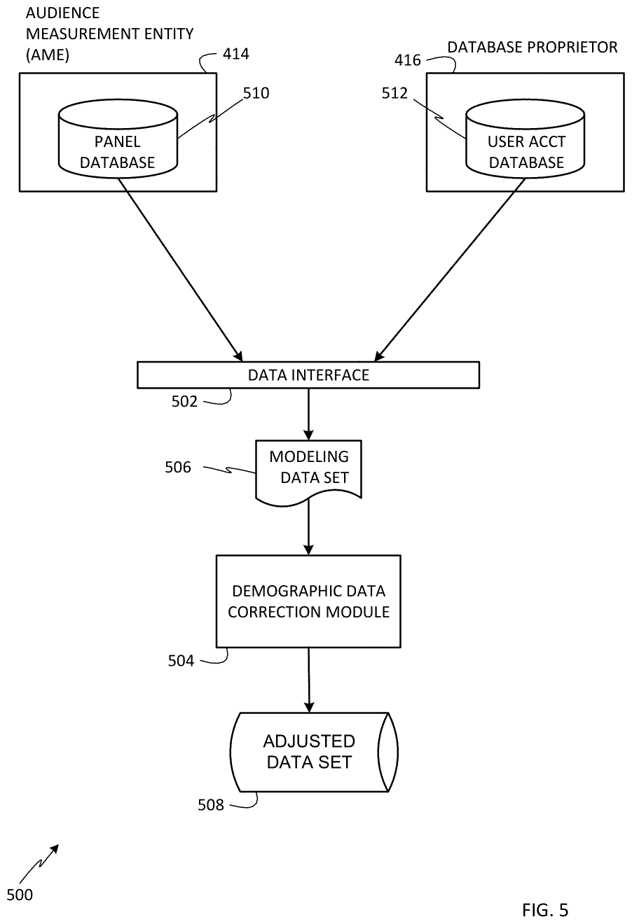

FIG. 5 illustrates an example apparatus 500 that may be used to model, analyze, and/or adjust demographic information of audience members. The apparatus 500 of the illustrated example includes a data interface 502 and a demographic data correction module 504 to process a modeling data set 506 to generate an adjusted data set 508 of audience demographic information. The modeling data set 506 is formed via the database interface 502 from a) known panelist data from a panelist database 510 provided by the AME 414 and b) user account information from a user account database 512 provided by the database proprietor 416. The example apparatus 500 and/or one or more of its components can be provided by the AME 414, the database proprietor 416, and/or an additional data analytics provider, for example.

In the example apparatus 500, the demographic data correction module 504 merges the panel information and data provider information in the modeling data set 506 and performs an exploratory data analysis on the merged information 506. Based on the data analysis, the demographic data correction module 504 creates and tests a correction model to adjust user demographics, such as age, etc., based on known panelist information from the panel database 510. The demographic data correction module 504 then applies the correction model to the data provider users from the user account database 512 and further tests to help ensure the model performs correctly (e.g., within a specified margin for error, standard deviation, threshold, etc.).

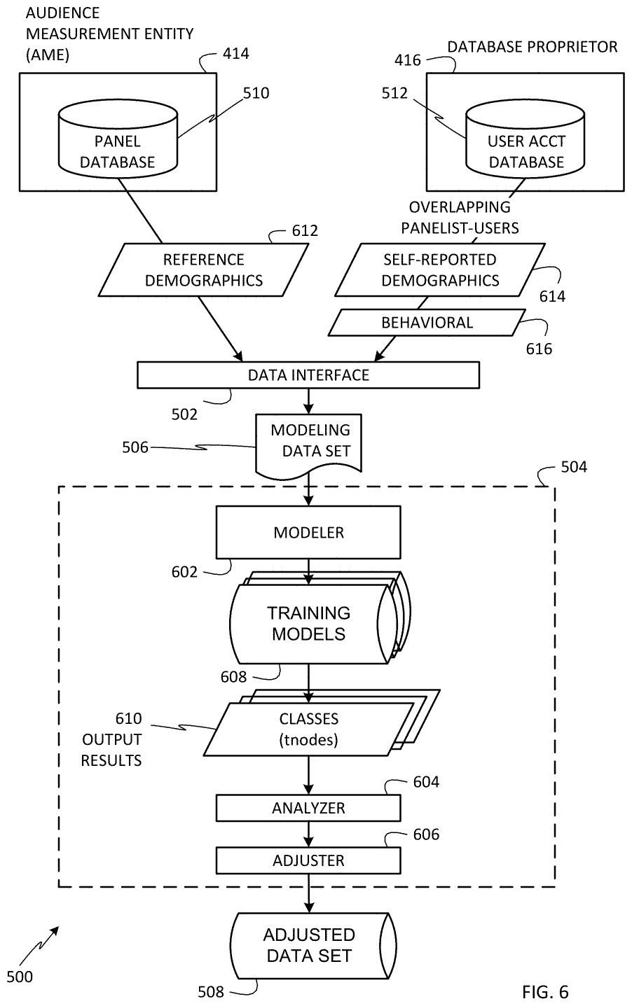

FIG. 6 illustrates a more detailed view of an implementation of the example apparatus 500 that may be used to model, analyze, and/or adjust demographic information of audience members. The apparatus 500 shown in the example of FIG. 6 provides additional detail regarding the example demographic data correction module 504. The example demographic data correction module 504 includes a modeler 602, an analyzer 604, an adjuster 606, training model(s) 608, and output results 610 (e.g., classes/categories and associated terminal nodes, such as age ranges, etc.). As discussed above, to obtain panel reference demographic data, self-reporting demographic data, and user online behavioral data from the AME 414 and the database proprietor 416, the example apparatus 500 is provided with the data interface 502. In the illustrated example of FIG. 6, the data interface 502 obtains reference demographics data 512 from the panel database 510 of the AME 414 storing highly reliable demographics information of panelists registered in one or more panels of the AME 414. In the illustrated example, the reference demographics information 612 in the panel database 510 is collected from panelists by the AME 414 using techniques which are highly reliable (e.g., in-person and/or telephonic interviews) for collecting highly accurate and/or reliable demographics. In the examples disclosed herein, panelists are persons recruited by the AME 414 to participate in one or more radio, movie, television and/or computer panels that are used to track audience activities related to exposures to radio content, movies, television content, computer-based media content, and/or advertisements on any of such media.

In addition, the data interface 502 of the illustrated example also retrieves self-reported demographics data 614 and/or behavioral data 616 from the user accounts database 512 of the database proprietor (DBP) 416 storing self-reported demographics information of users, some of which are panelists registered in one or more panels of the AME 414. In the illustrated example, the self-reported demographics data 614 in the user accounts database 512 is collected from registered users of the database proprietor 416 using, for example, self-reporting techniques in which users enroll or register via a webpage interface to establish a user account to avail themselves of web-based services from the database proprietor 416. The database proprietor 416 of the illustrated example may be, for example, a social network service provider, an email service provider, an internet service provider (ISP), or any other web-based or Internet-based service provider that requests demographic information from registered users in exchange for their services. For example, the database proprietor 416 may be any entity such as Facebook, Google, Yahoo!, MSN, Twitter, Apple iTunes, Experian, etc. Although only one database proprietor 416 is shown in the example of FIG. 6, the AME 414 may obtain self-reported demographics information from any number of database proprietors.

In the illustrated example, the behavioral data 616 (e.g., user activity data, user profile data, user account status data, user account data, etc.) may be, for example, graduation years of high school graduation for friends or online connections, quantity of friends or online connections, quantity of visited web sites, quantity of visited mobile web sites, quantity of educational schooling entries, quantity of family members, days since account creation, ‘.edu’ email account domain usage, percent of friends or online connections that are female, interest in particular categorical topics (e.g., parenting, small business ownership, high-income products, gaming, alcohol (spirits), gambling, sports, retired living, etc.), quantity of posted pictures, quantity of received and/or sent messages, etc.

In examples disclosed herein, a webpage interface provided by the database proprietor 416 to, for example, enroll or register users presents questions soliciting demographic information from registrants with little or no oversight by the database proprietor 416 to assess the veracity, accuracy, and/or reliability of the user-provided, self-reported demographic information 614. As such, confidence levels for the accuracy or reliability of self-reported demographics data 614 stored in the user accounts database 512 are relatively low for certain demographic groups. There are numerous social, psychological, and/or online safety reasons why registered users of the database proprietor 416 inaccurately represent or even misrepresent demographic information such as age, gender, etc.

In the illustrated example, the self-reported demographics data 614 and the behavioral data 616 correspond to overlapping panelist-users. Panelist-users are hereby defined to be panelists registered in the panel database 510 of the AME 414 that are also registered users of the database proprietor 416. The apparatus 500 of the illustrated example models the propensity for accuracies or truthfulness of self-reported demographics data based on relationships found between the reference demographics 612 of panelists and the self-reported demographics data 614 and behavioral data 616 for those panelists that are also registered users of the database proprietor 416.

To identify panelists of the AME 414 that are also registered users of the database proprietor 416, the data interface 502 of the illustrated example can work with a third party that can identify panelists that are also registered users of the database proprietor 416 and/or can use a cookie-based approach. For example, the data interface 502 can query a third-party database that tracks people who have registered user accounts at the database proprietor 416 and are also panelists of the AME 414. Alternatively, the data interface 502 can identify panelists of the AME 414 that are also registered users of the database proprietor 416 based on information collected at web client meters installed at panelist client computers for tracking cookie identifiers (IDs) for the panelist members. Such cookie IDs can be used to identify which panelists of the AME 414 are also registered users of the database proprietor 416. In either case, the data interface 502 can effectively identify all registered users of the database proprietor 416 that are also panelists of the AME 414.

After distinctly identifying those panelists from the AME 414 that have registered accounts with the database proprietor 416, the data interface 502 queries the user account database 512 for the self-reported demographic data 614 and the behavioral data 616. In addition, the data interface 502 compiles relevant demographic and behavioral information into a panelist-user data table or modeling data set 506. In some examples, the modeling data set 506 may be joined to the entire user base of the database proprietor 416 based on, for example, cookie values, and cookie values may be hashed on both sides (e.g., at the AME 414 and at the database proprietor 416) to protect privacies of registered users of the database proprietor 416.

The data interface 502 populates a modeling subset of data 506 based on non-duplicate entries from the reference demographics 612 and self-reported demographics 614 from the databases 510, 512. In the illustrated example, the data interface 102 provides the panelist-user data 506 for use by the modeler 602 of the demographic data correction module 504.

In the illustrated example of FIG. 6, the apparatus 500 is provided with the modeler 602 to generate a plurality of training models 608. The apparatus 500 selects from one of the training models 608 to serve as an adjustment model that is deliverable to the database proprietor 416 for use in analyzing and adjusting other self-reported demographic data 614 in the user account database 512. In the illustrated example, each of the training models 608 is generated from a training set selected from the panelist-user data 506. For example, the modeler 602 generates each of the training models 608 based on a different percentage of the panelist-user data 506. Each of the training models 608 is then based on a different combination of data in the panelist-user modeling data set 506.

Each of the training models 608 of the illustrated example includes two components: tree logic and a coefficient matrix. The tree logic refers to all of the conditional inequalities characterized by split nodes between root and terminal nodes, and the coefficient matrix contains values of a probability density function (PDF) of AME demographics (e.g., panelist ages of age categories shown in an AME age category table 200 of FIG. 2) for each terminal node of the tree logic. In the terminal node table 300 of FIG. 3, coefficient matrices of terminal nodes are shown in A_PDF through M_PDF columns 304 in the terminal node table 300.

In the illustrated example, the modeler 602 is implemented using a classification tree (ctree) algorithm from the R Party Package, which is a recursive partitioning tool described by Hothorn, Hornik, & Zeileis, 2006. The R Party Package may be advantageously used when a response variable (e.g., an AME age group of an AME age category table 200 of FIG. 2) is categorical, because a ctree of the R Party Package accommodates non-parametric variables. Another example advantage of the R Party Package is that the two-sample tests executed by the R Party Package party algorithm give statistically robust binary splits that are less prone to over-fitting than other classification algorithms (e.g., such as classification algorithms which utilized tree pruning based on cross-validation of complexity parameters, rather than hypothesis testing). The modeler 602 of the illustrated example generates tree models composed of root, split, and/or terminal nodes, representing initial, intermediate, and final classification states, respectively.

In the illustrated examples disclosed herein, the modeler 602 initially randomly defines a partition within the modeling dataset of the panelist-user data 506 such that different percentage (e.g., 80%, 70%, etc.) subsets of the panelist-user data 506 are used to generate the training models 608 (e.g., a training data set). Next, the modeler 602 specifies the variables that are to be considered during model generation for splitting cases in the training models 608. In the illustrated example, the modeler 602 selects ‘rpt-agecat’ as the response variable for which to predict. In the illustrated example, ‘rpt-agecat’ represents AME reported ages of panelists collapsed into buckets (e.g., age ranges). FIG. 2 shows an example AME age category table 200 containing a breakdown of age groups 220 established by the AME 414 for its panel members. An example advantage of predicting for groups of ages rather than exact ages is that it is relatively simpler to predict accurately for a bigger target (e.g., a larger quantity of people).

In the illustrated example, the modeler 602 uses a plurality of variables as predictors from the self-reported demographics 614 and the behavioral data 616 of the database proprietor 416 to split the cases. For example, age, gender, year of high school graduation, current address, user profile picture, screen name, mobile phone, birthday (e.g., included, omitted, visible, hidden, etc.), quantity of friends, user activity occurring within a time period (e.g., 7 days, 30 days, etc.), registered email address, median age of online friends, median age of online registered friends, percent of friends that are female, etc. In the illustrated example, the modeler 602 omits any variable having little to no variance or a high number of null entries.

In the illustrated example, the modeler 602 performs multiple hypothesis tests in each node and implements compensations such as using standard Bonferroni adjustments of p-values (e.g., probability of obtaining a result equal to or more extreme than what was observed). In the illustrated example, any single training model 608 generated by the modeler 602 may exhibit unacceptable variability in final analysis results procured using the training model 608. To provide the apparatus 500 with a training model 608 that operates to yield analysis results with acceptable variability (e.g., a stable or accurate model), the modeler 602 of the illustrated example executes a model generation algorithm iteratively (e.g., one hundred (100) times) based on the parameters specified by the modeler 602.

For each of the training models 608 and their associated output classes (e.g., terminal nodes) 610, the analyzer 604 analyzes the set of variables used by the training model 608 and the distribution of output values to make a final selection of one of the training models 608 for use as the adjustment model for the adjusted data set 508. In particular, the analyzer 604 performs its selection by (a) sorting the training models 608 based on their overall match rates collapsed over age buckets (e.g., the age categories shown in the AME age category table 200 of FIG. 2); (b) excluding ones of the training models 608 that produce results beyond a standard deviation from an average of results from all of the training models 608; (c) from those training models 608 that remain, determining which combination of variables occurs most frequently; and (d) choosing one of the remaining training models 608 that outputs acceptable results that recommend adjustments to be made within problem age categories (e.g., ones of the age categories of the AME age category table 200 in which ages of the self-reported demographics 614 are false or inaccurate) while recommending no or very little adjustments to non-problematic age categories. In the illustrated example, one of the training models 608 selected to use as the adjustment model includes the following variables: user age reported to database proprietor, number of online friends, median age of online registered friends, birthday is hidden as private, median age of online friends, year of high school graduation, and age reported to database proprietor 416.

In the illustrated example, to evaluate the training models 608, output results 610 are generated by the training models 608. Each output result set 610 is generated by a respective training model 608 by applying the model 608 to a portion (e.g., a training set such as 80%, 70%, etc.) of the modeling data set 506 used to generate the training model 608 and to the corresponding remainder (e.g., a test set such as 20%, 30%, etc.) of the modeling panelist-user data set 506 that was not used to generate the training model 608. The analyzer 604 performs intra-model 608 comparisons based on results from the portions (e.g., 80% and 20%, 70% and 30%, etc.) of the modeling data set 506 to determine which of the training models 608 provide consistent results across data that is part of the training model (e.g., the 705, 80%, etc., data set used to generate the training model 608, also referred to as the training data set) 608 and data to which the training model 608 was not previously exposed (e.g., the 20%, 30%, etc., data set, also referred to as the testing data set). In the illustrated example, for each of the training models 608, the output results 610 include a coefficient matrix (e.g., A_PDF through M_PDF columns 304 of FIG. 3) of the demographic distributions (e.g., age distributions) for the classes (e.g., age categories shown in an AME age category table 200 of FIG. 2) of the terminal nodes 302a-c.

As discussed above, FIG. 3 shows an example terminal node table 300 showing tree model predictions for multiple leaf nodes of the output results 610. The example terminal node table 300 shows three leaf node records 302a-c for three leaf nodes generated using the training models 608. Although only three leaf node records 302a-c are shown in FIG. 3, the example terminal node table 300 includes a leaf node record for each AME age falling into the AME age categories or buckets 220 shown in the AME age category table 200.

In the illustrated example, each output result set 610 is generated by running a respective training model 608 to predict the AME age bucket (e.g., the age categories 220 of the AME age category table 200 of FIG. 2) for each leaf. The analyzer 604 uses the resulting predictions to test the accuracy and stability of the different training models 608. In examples disclosed herein, the training models 608 and the output results 610 are used to determine whether to make adjustments to demographic information (e.g., age), but are not initially used to actually make the adjustments. For each row 302a-c in the terminal node table 200, which corresponds to a distinct terminal node (T-NODE) for each training model 608, accuracy is defined as a proportion of database proprietor observations that have an exact match in age bucket to the AME age bucket 220. In the illustrated example, the analyzer 604 evaluates each terminal node individually.

In the illustrated example, the analyzer 604 evaluates the training models 608 based on two adjustment criteria: (1) an AME-to-DBP age bucket match, and (2) out-of-sample reliability. Prior to evaluation, the analyzer 604 modifies values in the coefficient matrix (e.g., the A_PDF through M_PDF columns 304 of FIG. 3) for each of the training models 608 to generate a modified coefficient matrix. By generating the modified coefficient matrix, the analyzer 604 normalizes the total number of users for particular training model 608 to one such that each coefficient in the modified coefficient matrix represents a percentage of the total number of users. After the analyzer 604 evaluates the coefficient matrix (e.g., the A_PDF through M_PDF columns 304 of FIG. 3) for each terminal node of the training models 608 against the two adjustment criteria (e.g., (1) an AME-to-DBP age bucket match, and (2) out-of-sample reliability), the analyzer 604 can provide a selected modified coefficient matrix as part of the adjustment model to be used by the adjuster 606 to provide the adjusted data set 508 deliverable for use by the database proprietor 416 on any number of users.

During the evaluation process, the analyzer 604 performs AME-to-DBP age bucket comparisons, which is a within-model evaluation, to identify ones of the training models 608 that do not produce acceptable results based on a particular threshold. In this manner, the analyzer 604 can filter out or discard ones of the training models 608 that do not show repeatable results based on their application to different data sets. That is, for each training model 608 applied to respective 80%/20% data sets, for example, the analyzer 604 generates a user-level DBP-to-AME demographic match ratio by comparing quantities of DBP registered users that fall within a particular demographic category (e.g., the age ranges of age categories 220 shown in an AME age category table 200 of FIG. 2) with quantities of AME panelists that fall within the same particular demographic category. For example, if the results 610 for a particular training model 608 indicate that 100 AME panelists fall within the 25-29 age range bucket and indicate that 90 DBP users fall within the same bucket (e.g., an age bucket of age categories 220 shown in an AME age category table 200 of FIG. 2), the user-level DBP-to-AME demographic match ratio for that training model 608 is 0.9 (90/100). If the user-level DBP-to-AME demographic match ratio is below a threshold, the analyzer 604 identifies the corresponding one of the training models 608 as unacceptable for not having acceptable consistency and/or accuracy when run on different data (e.g., the 80% data set and the 20% data set).

After discarding unacceptable ones of the training models 608 based on the AME-to-DBP age bucket comparisons of the within-model evaluation, a subset of the training models 608 and corresponding ones of the output results 610 remain. The analyzer 604 then performs an out-of-sample performance evaluation on the remaining training models 608 and the output results 610. To perform the out-of-sample performance evaluation, the analyzer 604 performs a cross-model comparison based on the behavioral variables in each of the remaining training models 608. That is, the analyzer 604 selects ones of the training models 608 that include the same behavioral variables. For example, during the modeling process, the modeler 602 may generate some of the training models 608 to include different behavioral variables. Thus, the analyzer 604 performs the cross-model comparison to identify those ones of the training models 608 that operate based on the same behavioral variables.

After identifying ones of the training models 608 that (1) have acceptable performance based on the AME-to-DBP age bucket comparisons of the within-model evaluation and (2) include the same behavioral variables, the analyzer 604 selects one of the identified training models 608 for use as the deliverable adjustment model 508. After selecting one of the identified training models 608, the adjuster 606 performs adjustments to the modified coefficient matrix of the selected training model 608 based on assessments performed by the analyzer 604.

The adjuster 606 of the illustrated example of FIG. 6 is configured to make adjustments to age assignments in cases where there is sufficient confidence that the bias being corrected for is statistically significant. Without such confidence that an uncorrected bias is statistically significant, there is a potential risk of overzealous adjustments that could skew age distributions when applied to a wider registered user population of the database proprietor 416. To avoid making such overzealous adjustments, the analyzer 604 uses two criteria to determine what action to take (e.g., whether to adjust an age or not to adjust an age) based on a two-stage process: (a) check data accuracy and model stability first, then (b) reassign to another age category only if accuracy will be improved and the model is stable, otherwise leave data unchanged. That is, to determine which demographic categories (e.g., age categories 220 shown in an AME age category table 200 of FIG. 2) to adjust, the analyzer 604 performs the AME-to-DBP age bucket comparisons and identifies categories to adjust based on a threshold. For example, if the AME demographics indicate that there are 30 people within a particular age bucket and less than a desired quantity of DBP users match the age range of the same bucket, the analyzer 604 determines that the value of the demographic category for that age range should be adjusted. Based on such analyses, the analyzer 604 informs the adjuster 606 of which demographic categories to adjust. In the illustrated example, the adjuster 606 then performs a redistribution of values among the demographic categories (e.g., age buckets). The redistribution of the values forms new coefficients of the modified coefficient matrix for use as correction factors when the adjustment model 508 is delivered and used by the database proprietor 416 on other user data (e.g., self-reported demographics 614 and behavioral data 616 corresponding to users for which media impressions are logged).

In some examples, to analyze and adjust self-reported demographics data from the database proprietor 416 based on users for which media impressions were logged, the database proprietor 416 delivers aggregate audience and media impression metrics to the AME 414. These metrics are aggregated not into multi-year age buckets (e.g., such as the age buckets 220 of the AME age category table 200 of FIG. 2), but in individual years. As such, prior to delivering the PDF to the database proprietor 416 to implement the adjustment model 508 in their system, the adjuster 606 redistributes the probabilities of the PDF from age buckets into individual years of age. In such examples, each registered user of the database proprietor 416 is either assigned their initial self-reported age or adjusted to a corresponding AME age depending on whether their terminal node met an adjustment criterion. Tabulating the final adjusted ages in years, rather than buckets, by terminal nodes and then dividing by the sum in each node splits the age bucket probabilities into a more useable, granular form, for example.

In some examples, after the adjuster 606 determines the adjustment model 508, the model 508 is provided to the database proprietor 416 to analyze and/or adjust other self-reported demographic data 614 of the database proprietor 416. For example, the database proprietor 416 may use the adjustment model 508 to analyze self-reported demographics 614 of users for which impressions to certain media were logged. The database proprietor 416 can generate data indicating which demographic markets were exposed to which types of media and, thus, use this information to sell advertising and/or media content space on web pages served by the database proprietor 416. In addition, the database proprietor 416 can send their adjusted impression-based demographic information to the AME 414 for use by the AME 414 in assessing impressions for different demographic markets.

In the examples disclosed herein, the adjustment model 508 is subsequently used by the database proprietor 416 to analyze other self-reported demographics 614 and behavioral data 616 from the user account database 512 to determine whether adjustments to such data should be made.

Analysis and Adjustment of Age Demographic Information

Disclosed examples include collecting true or “truth” information from panelists and merging the truth data set with demographic information provided by a data proprietor. In some disclosed examples, when a user accesses (e.g., views) tagged media, pings are generated at the user's device and sent to the data proprietor 416 and to an audience measurement entity (AME) 414 server. The data proprietor 416 can then aggregate demographic information corresponding to the users who accessed the tagged media and provide the aggregated demographic information to the AME 414. In some examples, the AME 414 uses the demographic information provided by the data proprietor 416 to estimate demographic distributions of the visitors of the tagged media.

However, in some instances, the users may not provide accurate (e.g., truthful) information to the data proprietor (e.g., lying about age, etc.). If users are false or in accurate in representing their ages (e.g., their age ranges or categories, etc.), error is introduced into the audience measurement data.

In some disclosed examples, the AME 414 generates corrective models to account for incorrect self-reported age. In some examples, the AME server merges the data proprietor information with “truthful” information provided by the panelist. For example, the AME server can map data proprietor information to known information (e.g., the “truth” information) based on user identifier included in the data proprietor information and the ping that the AME server received. Examples disclosed herein then generate corrective models to predict accurate ages for unknown users.

Thus, in some examples, the data proprietor 416 provides demographic information for their users who have viewed media, and the audience measurement entity 414 provides corrective models to account for incorrect self-reported age, misattribution, and/or coverage, for example. In some examples, such as disclosed above with respect to FIGS. 5-6, a decision tree model is used to correct self-reported age. For example, the decision tree model recursively performs binary splits on a training data set until a stopping criterion is satisfied (e.g., a terminal node is reached). In some such examples, a set of users from the training set with an age distribution is determined at each terminal node.

In some such examples, the leaves of the decision trees (e.g., the terminal nodes) represent a distribution of ages. For example, the AME server may use the decision tree to determine the lying patterns of the users. For example, a terminal node corresponding to a 30 year-old male may include a distribution of likely true ages of the user (e.g., a 30% chance the user is 29 years old, a 30% chance the user is 30 years old, and a 40% chance the user is 31 years old).

In some examples, the age distribution is used to predict the age of an unknown user at that terminal node. Two example methods to use the age distribution to predict the age of an unknown user include single class prediction and distributed class prediction.

In some examples, a single class prediction approach is used to predict the age of unknown users. For example, a mode (e.g., most likely value) of the age distribution can be assigned to the unknown users at that terminal node.

In some examples, a distributed class prediction approach is used to predict the age of unknown users. In this approach, the unknown users are probabilistically members of one or more classes (e.g., all available classes), where their respective probability of class membership corresponds to (e.g., is equivalent to) the age distribution of the users in the training set.

In some examples, whether the single class prediction approach is used or the distributed class prediction approach is used depends on a scope of the corresponding media campaign. For example, the single class prediction approach may be beneficial (e.g., provide high accuracy) in highly targeted media campaigns. In other examples, the distributed class prediction approach may be beneficial in broad-based media campaigns. In some examples, the distributed class prediction approach may be used to handle terminal nodes that do not clearly identify a single class (e.g., 20% class 1, 38% class 2 and 42% class 3). However, the distributed class prediction approach may perform poorly when a terminal node includes a large number of users from one class, with only a small number of users from other classes.

Examples disclosed herein employ a hybrid model to map a terminal node distribution to a degenerate distribution (e.g., a distribution with a single value) and/or to maintain a probability distribution for the terminal node. In some disclosed examples, the AME server 414 (e.g., via the example analyzer 604 and/or adjuster 606) determines whether to map the terminal node distribution to a degenerate distribution (e.g., a single value) or utilize a distributed class prediction (e.g., a probability density function including a plurality of possible age categories or classes 220) based on a distance between the terminal node distribution and the degenerate distribution. In some disclosed examples, if a distance (d) between the terminal node distribution and a degenerate distribution (e.g., a distribution of a single value) satisfies a distance threshold, the example AME server maps the terminal node distribution to the degenerate distribution. For example, the distance between the terminal node distribution and the degenerate distribution may represent an amount of uncertainty. In some examples, when the amount of uncertainty satisfies the distance threshold, the example AME server modifies the terminal node distribution to the degenerate distribution (e.g., single value). In some examples, when the amount of uncertainty does not satisfy the distance threshold, the example AME server does not modify the terminal node distribution.

In some disclosed examples, the AME server processes each of the terminal nodes and assigns a distribution (e.g., a degenerate distribution or a distributed probability distribution) to each of the terminal nodes. The example AME server then uses the assigned distributions to predict the true age of the unknown users.

More specifically, examples disclosed herein adjust or “snap” a terminal node distribution to a single value (e.g., also referred to as a degenerate distribution or deterministic distribution). In certain examples, if a distance (d) between a terminal node distribution and a degenerate distribution (e.g., a distribution of a single value) satisfies a distance threshold, the terminal node distribution is mapped to the degenerate distribution (e.g., the probability distribution function is replaced by a single value). In some examples, the distance (d) between the terminal node distribution and the degenerate distribution is determined based on a complement of a probability of a most likely value (e.g., 100% minus the probability of the most likely value, or the probability that the value is one other than the most likely value). In some examples, the distance (d) between the terminal node distribution and a degenerate distribution is determined based on an entropy of the distribution. In some examples, the distance (d) represents an amount of uncertainty of the terminal node distribution based on information theory. In examples disclosed herein, when the distance (d) between the terminal node distribution and a degenerate distribution satisfies a distance threshold, the terminal node distribution is modified to be the degenerate distribution.

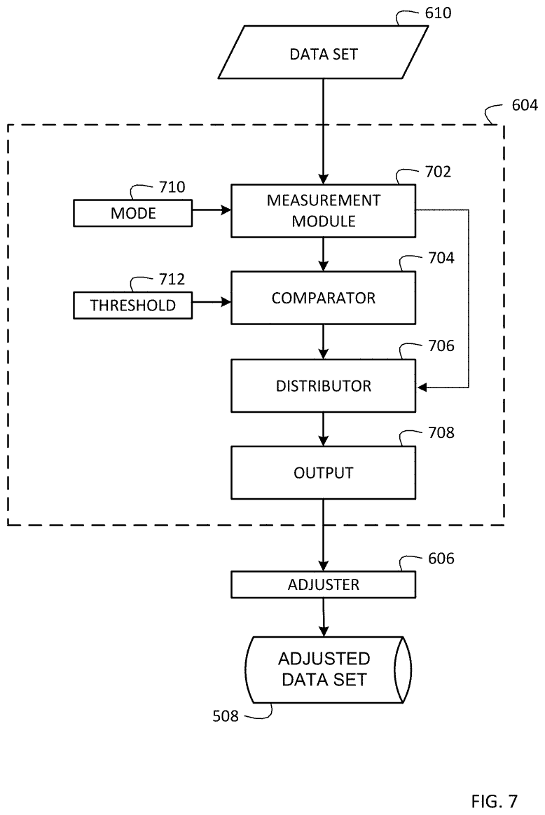

FIG. 7 illustrates further detail regarding an example implementation of the analyzer 604. The example analyzer 604 in FIG. 7 analyzes and adjusts age information (e.g., age range or classification, etc.) to identify and correct falsification and/or other inaccuracy in user age demographic data. As shown in the example of FIG. 7, the analyzer 604 includes a data measurement module 702, a comparator 704, a distributor 706, and an output 708. The analyzer 604 receives data, such as the output results 610 from the training model 608, and processes the data (e.g., terminal node data such as terminal nodes 302a-c from the example table 300 of FIG. 3) to generate the output 708 to be adjusted by the adjuster 606 and provided as an adjusted data set 508 for accurate audience measurement reporting.

The measurement module 702 processes the input data to measure constituent values in the input data (e.g., the probability density function or PDF as described above with respect to the terminal nodes 302a-c of FIG. 3). In certain examples, an indication of a mode or type of marketing campaign 710 factors into the processing by the measurement module 702. For example, if the mode 710 is a broad or general campaign mode (e.g., analysis is being conducted for an advertising campaign that broadly targets consumers), then the probability distribution of the incoming data can be maintained. However, if the mode 710 is a targeted campaign mode (e.g., analysis is being conducted for an advertising campaign that narrowly or specifically targets certain customers), then the data is further analyzed to determine whether a degenerate distribution (e.g., a single value) can be used in place of the existing probability distribution. In some examples, the degenerate distribution analysis is executed regardless of a mode or type of campaign. In some examples, the mode or type of campaign may not be known by the analyzer 604.

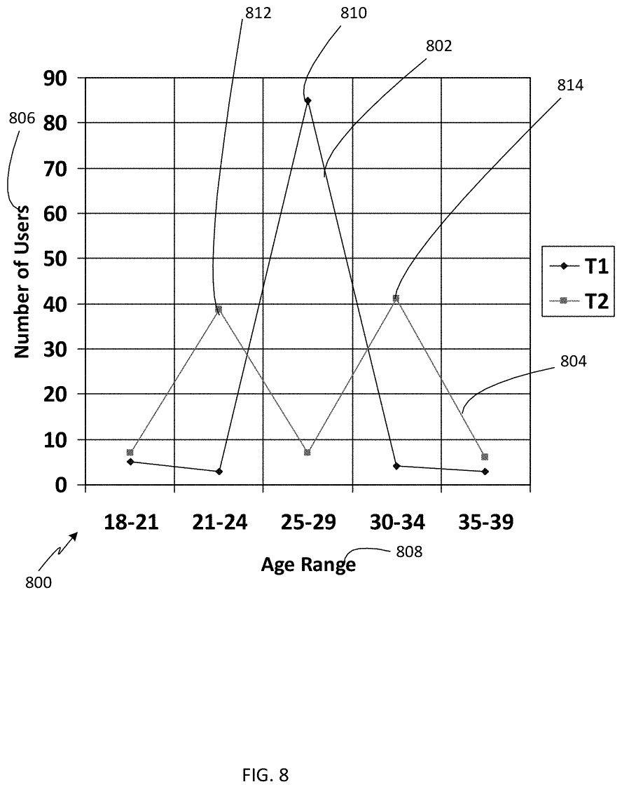

For example, FIG. 8 illustrates a graph 800 of two example user age distributions 802, 804 at terminal nodes T1 and T2, respectively. The example graph 800 provides a plot of a number of monitored users 806 in each age range 808 (e.g., the age ranges 220 of the example of FIG. 2) by terminal node from the monitored user data (e.g., data from the user account database 512 and/or panelist database 510 input as the modeling data set 506, etc.). As illustrated in the example of FIG. 8, the distribution 802 for terminal node T1 includes a single majority peak 810 indicating that most of that age probability distribution 802 falls within one age range 808 (e.g., 80% confident that a user at the terminal node T1 is in the age range 808 of ages 25-29 in the example of FIG. 8), and only a minor percentage fall outside of that age range 808. That is, as shown in the example graph 800, only one significant peak 810 occurs in the probability distribution 802 of age among users 806 at T1.

In contrast, the graph of age distribution 804 at terminal node T2 includes a plurality of measurable peaks 812, 814. As shown in the example of FIG. 8, no majority peak is present in the distribution 804 of T2. Rather, a plurality of peaks 812, 814 of approximately the same size are found in the example distribution 804. Thus, there is no single majority age range 808 in the distribution 804 of users 806 at T2.

In certain examples, the measurement module 702 processes incoming data to identify whether the data distribution includes a single largest peak (similar to the peak 810 in the example distribution 802 at terminal node T1 in the example of FIG. 8) or includes a plurality of measurable peaks (similar to the peaks 812, 814 in the example distribution 804 at terminal node T2 in the example of FIG. 8).

In the example of FIG. 8, the distributions 802 and 804 represent a probability of user age at terminal nodes T1 and T2, respectively. (e.g., a PDF for terminal node 302a-302c in the terminal node table 300 in the example of FIG. 3) in a decision tree. The measurement module 702 processes the distribution 802 at the terminal node T1 to determine that the distribution is very “peaky” or defined by a single strong peak to provide certainty regarding user age (e.g., in which the system 500 is 95% confident that the user is between 25 and 29, etc.).

The measured data is provided by the measurement module 702 to the comparator 704. In some examples, if the campaign mode 710 indicates to the measurement module 702 that the campaign is a broad campaign and/or otherwise that further analysis with respect to a degenerate distribution is unwarranted, then the measurement module 702 can bypass the comparator 704 and send the distribution data to the distributor 706.

The comparator 704 examines the measured data of the distribution (e.g., the age probability distribution 802 and/or 804, etc.) and compares the data to a threshold 712. The outcome of the comparison and the data are provided by the comparator 704 to the distributor 706. Depending upon whether the measured data is a) greater than or b) less than or equal to the threshold 712, the data is processed to maintain its existing probability distribution function (PDF) or to “snap” the data value(s) to a single value or degenerate distribution. Thus, the distributor 706 processes the incoming data and the comparator 704 output to generate a “hybrid PDF”. The distributor 706 provides the hybrid PDF as the output 708, which feeds the adjusted data set or model 508.

As illustrated in the example of FIG. 8, the distribution 802 at terminal node T1 demonstrates a high likelihood of a single age range 808. Such a high likelihood distribution 802 can trigger a snap to a single value (e.g., e.g., setting the probability of user age range to a degenerate distribution of 100% at ages 25-29 per the peak 810 in the example of FIG. 8) for users at terminal node T1. Conversely, a more varied distribution 804 at terminal node T2 has no majority or dominant peak, and does not lend itself to a single value. Instead, the original distribution 804 should be maintained (e.g., the range of probabilities that a user is ages 21-24, per peak 812, is ages 30-34 per peak 814, etc.).

In some disclosed examples, the distance threshold 712 used by the comparator 704 is determined based on a parameter sweep of thresholds. In some disclosed examples, a targeted accuracy and a broad accuracy are determined for different threshold values (e.g., entropy thresholds). In some such examples, the targeted accuracy and the broad accuracy are combined. For example a single score may be calculated based on an average (e.g., a simple average, a weighted average (e.g., based on mode, etc.), etc.) of the targeted accuracy and the broad accuracy. In some examples, the distance threshold represents the threshold corresponding to the highest score.

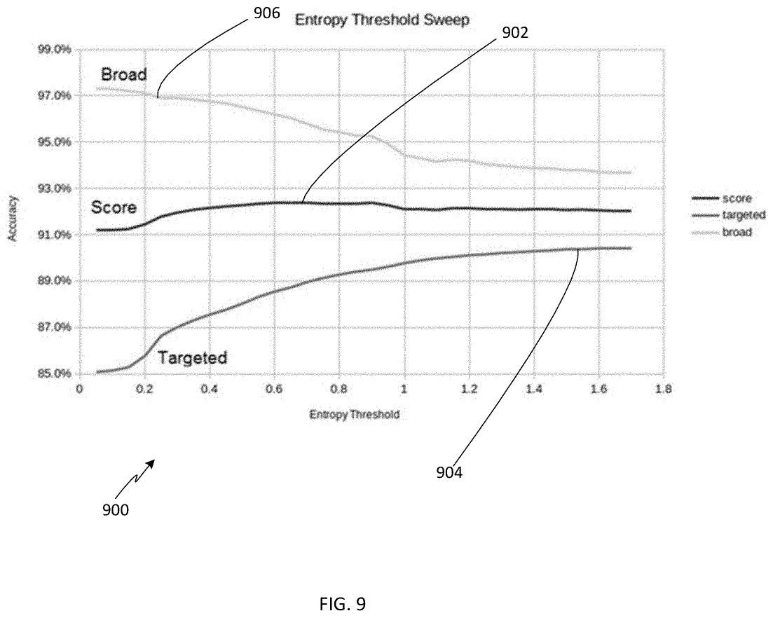

FIG. 9 depicts an example graph 900 illustrating an example parameter sweep to determine an adjustment threshold. In the illustrated example, the distance threshold 712 is determined as an entropy threshold that maximizes a score line 902 in a balance (or trade off) between a targeted accuracy 904 and a broad accuracy 906. For example, in the illustrated graph 900, a maximum score 902 is determined to be at an entropy threshold of 0.65. That score 902 provides a balance between a high targeted accuracy 904 and a high broad accuracy 906 and serves as a dividing line or threshold 712 by the comparator 704 when evaluation the distribution data (e.g., the age PDFs 802, 804 in the example of FIG. 8).

Thus, the comparator 704 applies the threshold 712 (e.g., an entropy threshold) to the data from the measurement module 702 to determine whether the data distribution should be adjusted to a single value in a degenerate distribution or maintained as a probability distribution function of a plurality of values and associated likelihoods.

In some disclosed examples, when the distance (d) does not satisfy the distance threshold 712, the terminal node distribution is unmodified. In some examples, the distribution for each terminal node of the decision tree is determined for the training data set. For example, a determination is made whether to “snap” the distribution at a terminal node to a degenerate distribution (e.g., a distribution with one value with a probability of 100%), or to leave the distribution at the terminal node unmodified. In some such examples, once all the terminal nodes are processed, the determined distributions are applied to the unknown users.

More specifically, an entropy or amount of information in a probability distribution associated with a terminal node is used by the comparator 704 in comparison to the threshold 712 to determine whether the distribution is a candidate for replacement or snapping to a single value from a distribution of multiple values. The entropy (e.g., Shannon entropy) of a distribution can be determined based on an expected or average value of the data or information in the distribution, for example. In some examples, a logarithm of the probability distribution can be used to measure the entropy of that distribution.

Entropy is zero when the outcome is certain. Since entropy is a measure of unpredictability of information content, a probability distribution with no unpredictability has an entropy of zero. Thus, an age distribution which is found by the comparator 704 to satisfy the threshold 712 (e.g., to be predictable and have low entropy) can be snapped to a single value or left as-is in its distribution. For example, a distribution (e.g., the distribution 802 of the example of FIG. 8) having an entropy of less than the threshold 712 (e.g., the score 902 identified in the example of FIG. 9) can be snapped to a particular value (e.g., the dominant peak 810 of the example of FIG. 8 at a probability of 100%, or an entropy of 0). However, a distribution (e.g., the distribution 804 of the example of FIG. 8) having an entropy of more than the threshold 712 (e.g., more peaks are associated with more information and, therefore, greater entropy), remains the same rather than being forced to a single value from a single peak in the distribution 804, for example.

The analysis output of the comparator 704 is provided to the distributor 706, which can adjust the probability distribution of the input data 610 (e.g., the age probability distribution) or leave the distribution unchanged. For example, if the comparator 704 indicates that the age probability distribution has a dominant peak 810, then the distributor 706 “snaps” or adjusts the distribution 802 to 100% at a single value (e.g., from a probability distribution 802 of a variety of values with a single dominant peak 810 to a single value of 100% at that dominant peak 810). However, if the comparator 704 indicates that the age probability distribution has a plurality of similar peaks 812, 814, then the distributor 706 can leave the original distribution 804 in place.

The distributor 706 provides the updated distribution as output 708. The output 708 is provided by the analyzer 604 to the adjuster 606 for finalization as the adjust data set/data model 508, as described above with respect to FIGS. 5-6.

While an example manner of implementing the example audience measurement apparatus 500 and associated components are illustrated in FIGS. 4-7, one or more of the elements, processes and/or devices illustrated in FIGS. 4-7 may be combined, divided, re-arranged, omitted, eliminated and/or implemented in any other way. Further, any of the example data interface 502, the example demographic data correction module 504, the example modeler 602, the example analyzer 604, the example adjuster 606, the example measurement module 702, the example comparator 704, the example distributor 706, and/or, more generally, the example apparatus 500 of FIGS. 4-7 may be implemented by hardware, software, firmware and/or any combination of hardware, software and/or firmware. Thus, for example, any of the example data interface 502, the example demographic data correction module 504, the example modeler 602, the example analyzer 604, the example adjuster 606, the example measurement module 702, the example comparator 704, the example distributor 706, and/or, more generally, the example apparatus 500 can be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example data interface 502, the example demographic data correction module 504, the example modeler 602, the example analyzer 604, the example adjuster 606, the example measurement module 702, the example comparator 704, the example distributor 706, and/or, more generally, the example apparatus 500 is/are hereby expressly defined to include a tangible computer readable storage device or storage disk such as a memory, a digital versatile disk (DVD), a compact disk (CD), a Blu-ray disk, etc. storing the software and/or firmware. Further still, the example apparatus 500 of FIGS. 4-7 may include one or more elements, processes and/or devices in addition to, or instead of, those illustrated in FIGS. 4-7, and/or may include more than one of any or all of the illustrated elements, processes and devices.

Example Analysis and Adjustment Methods

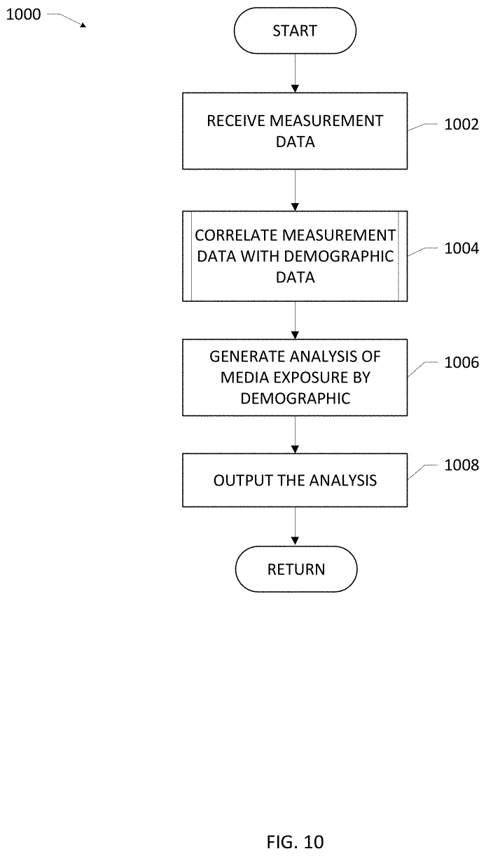

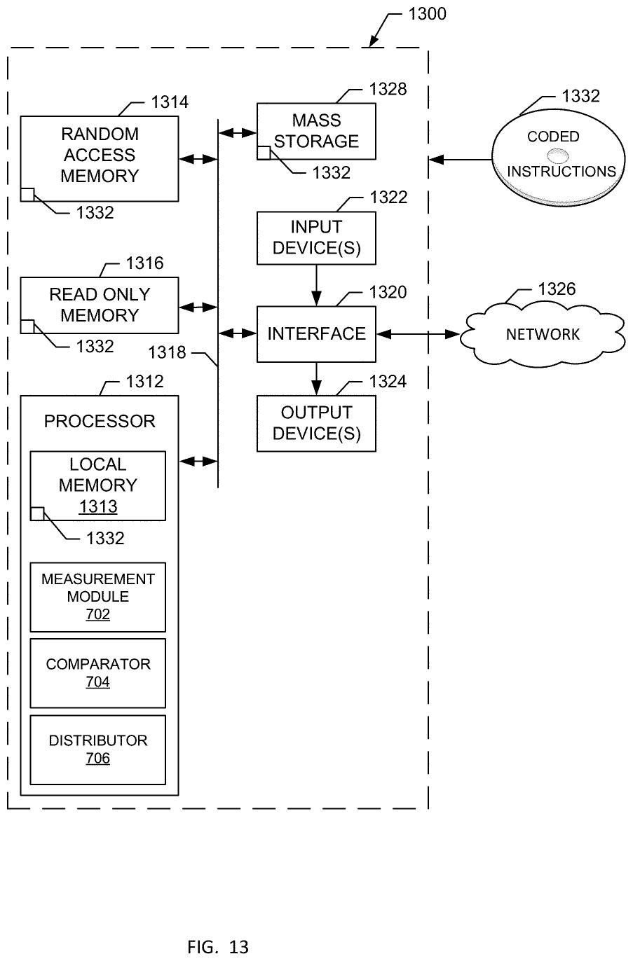

Flowcharts representative of example machine readable instructions for implementing the example analysis and adjustment apparatus 500 of FIGS. 4-7 are shown in FIGS. 10-12. In this example, the machine readable instructions comprise a program for execution by a processor such as the processor 1312 shown in the example processor platform 1300 discussed below in connection with FIG. 13. The program may be embodied in software stored on a tangible computer readable storage medium such as a CD-ROM, a floppy disk, a hard drive, a digital versatile disk (DVD), a Blu-ray disk, or a memory associated with the processor 1312, but the entire program and/or parts thereof could alternatively be executed by a device other than the processor 1312 and/or embodied in firmware or dedicated hardware. Further, although the example program is described with reference to the flowcharts illustrated in FIGS. 10-12, many other methods of implementing the example apparatus 500 of FIGS. 4-7 may alternatively be used. For example, the order of execution of the blocks may be changed, and/or some of the blocks described may be changed, eliminated, or combined.

As mentioned above, the example processes of FIGS. 10-12 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 10-12 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 10 is a flow diagram representative of example machine readable instructions 1200 that may be executed to implement an example data analysis and adjustment process including the example data analysis and adjustment apparatus 500 of FIG. 5 and its components (see, e.g., FIGS. 4-7).

At block 1002, a data processing system, such as the example data analysis and adjustment apparatus 500 receive measurement data (e.g., online audience measurement data, etc.) for processing. For example, the data interface 502 receives measurement data (e.g., exposures/impressions 408 of online/Internet/Web content, etc.) from one or more client devices 402 that have been gathered by the audience measurement entity 414 and/or the database proprietor 416.

At block 1004, the measurement data is correlated with demographic data. For example, measurement data regarding exposure to and/or impression of content (e.g., online, Internet and/or other Web-based content) is correlated and/or otherwise matched with user demographic information from the panel database 510 associated with the AME 414 and/or the user account database 512 associated with the database proprietor 416.

By correlating exposure data with demographic data, the AME 414 and/or other market researcher can determine who is viewing which content and can tailor advertising, discount, and/or other marketing campaign to one or more demographic segments. Incorrect determination and correlation of demographic data with content exposure can result in large, erroneous expenditures of time, money, and other resources to produce and distribute advertising, discount, and/or other marketing materials to an incorrect demographic, resulting in wasted spending, lost sales, improper product development, job loss, and economic inefficiency, for example. Therefore, it is important that such correlation be as accurate as possible given the circumstances (e.g., user inaccuracies, user omissions, user falsification, lack of data, etc.).

At block 1006, an analysis of media exposure is generated based on the correlated media exposure and user demographic data. A demographic segment and/or other audience demographic information can be generated based on a record of media exposure and demographic data regarding to whom the media has been exposed. Thus, as discussed above, persons/type(s) of people interested in certain media content (e.g., television shows, movies, advertisements, channels, products, services, etc.) can be identified, and associated metrics can be provided to affect marketing and/or development of media content, products, and/or services, for example.

At block 1008, the generated analysis is output (e.g., as a report, etc.) for consumption by the AME 414 and/or other marketing entity, product developer, service provider, etc. Such analysis can be an electronic data report, a graphical display of information, a presentation, an electronic input into another program, etc.

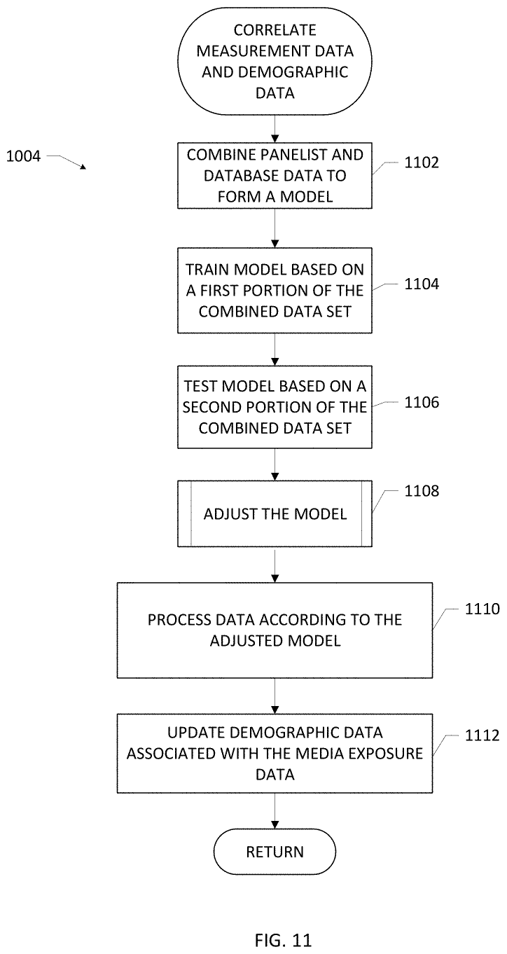

FIG. 11 is a flow diagram representative of example machine readable instructions that may be executed to implement the example demographic data correction module 504 of FIGS. 5-6. The example process of FIG. 11 provides additional and/or related detail regarding execution of block 1004 of the example process 1000 of FIG. 10 to correlate measurement and demographic data.

At block 1102, data from the panelist database 510 of the AME 414 and from the user account database 512 of the database proprietor 416 are combined to form a model. For example, the user data is organized according to a decision tree based on demographic characteristic, such as user age group/range (e.g., age range 220 of the example of FIG. 2).

At block 1104, the model is trained based on a first portion of the combined data set. For example, a certain percentage (e.g., 70%, 80%, etc.) of the available data is used to train the decision tree model, which classifies user age using a decision tree by analyzing user inputs and clustering those inputs based on common response to form clusters or groups. The user input data is processed recursively to form tight groups at end points or terminal nodes in the tree structure. Thus, at terminal nodes in a tree, a group of users is organized based on their input and/or monitored data who in theory have the same age (e.g., are in the same age range or age group). However, in reality, not all users in a group at a terminal node are in fact the same age. A probability distribution (e.g., a probability distribution function or PDF) is determined based on one or more criterion indicating a probability of user age distribution at the terminal node based on user registration information, monitored user data, correlated panelist information, etc.

At block 1106, the trained model is tested using a second portion of the combined data set. For example, a remainder (e.g., 30%, 20%, etc.) of the available data, which was not used to the train the model, is then used to test the model. The model is analyzed with the test data to determine whether the model holds true as trained when the test data is applied. If not, the model can be tweaked (e.g., terminal nodes adjusted, PDFs modified, etc.) based on observed results from the test data.

Thus, for example, suppose a decision tree is formed from a group of 10,000 users for which their true age and online behavior are known (e.g., panelists, etc.). From the group of 10,000, 7000 are selected to train the model, and 3000 users are saved for testing of the model. Terminal nodes and associated age probability distributions are created (e.g., 100 terminal nodes formed in the tree for 7000 users, etc.) and trained using patterns and information from the 7000 users. The model is then tested on the remaining 3000 users to help ensure that the model properly identifies its data, pattern(s), relationship(s), etc.

At block 1108, the model is adjusted based on one or more factors. For example, one or more factors such as information entropy, probability, and/or other correction factor can be applied to the model to adjust the model to better account for discrepancy in user demographic data, such as user age range.

At block 1110, data is processed according to the adjusted model. For example, corrected age data and/or other demographic data is processed according to the adjusted model to provide corrected demographic data for media exposure. At block 1112, the updated/corrected demographic data is associated with the media exposure data. The media exposure information, combined with user demographics, can be provided to a third party such as a marketer, AME 414, product retailer, service provider, etc.

Thus, in certain examples, online advertisements can be tagged to trigger a redirect when the advertisement is viewed by a user. The user's identification (e.g., Facebook identifier, panelist ID, LinkedIn identification, etc.) is captured and aggregated with other users who viewed the ad. A terminal node, with its associated age group, is identified for each individual who viewed the ad. For example, suppose ten users are in terminal node A, and twenty users are in terminal node B. A distribution of age is computed for terminal node A and terminal node B. The age distribution at each terminal node can be adjusted based on one or more criterion to modify or retain the age distribution, which can then be provided as output to a market researcher.

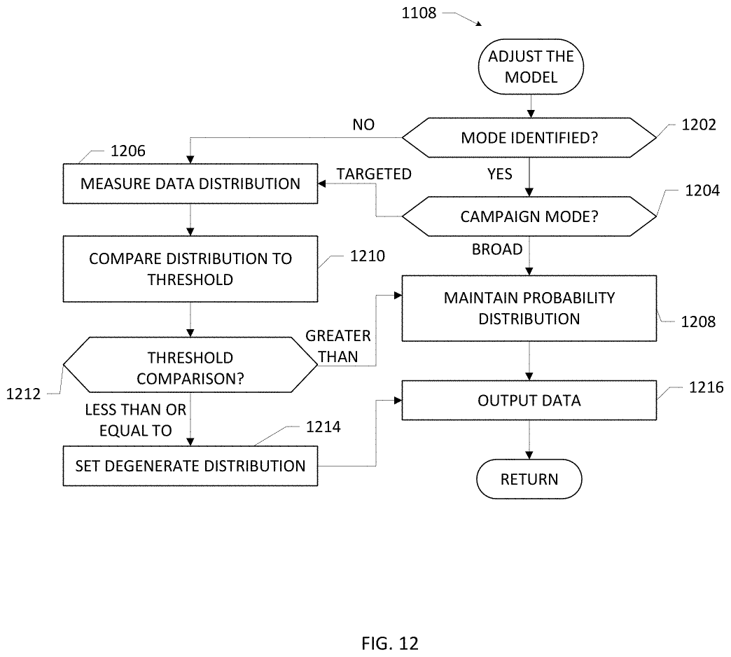

FIG. 12 is a flow diagram representative of example machine readable instructions that may be executed to implement the example analyzer 604 of FIGS. 6-7. The example process of FIG. 12 provides additional and/or related detail regarding execution of block 1108 of the example process 1004 of FIG. 11 to adjust a demographic data model (e.g., a user age distribution data model, etc.).

At block 1202, the example analyzer 604 of the example demographic data correction module 504 determines whether a mode identifier 710 is present in the system 500. For example, the demographic data correction module 504 may receive and/or be able to retrieve an indication of a campaign mode for an advertisement and/or other media being monitored. If the mode 710 is known, then, at block 1204, the mode 710 is examined. If, however, the mode 710 is unknown and/or otherwise, unavailable, then at block 1206, a data distribution is examined.

At block 1204, if the mode 710 is known, the mode is examined to determine a value or setting of the campaign mode 710. If the campaign is a targeted campaign, for example, then control proceeds to block 1206 at which a data distribution associated with the model data is measured. If the campaign is a broad campaign, then, at block 1208, a probability distribution associated with the modeled data is maintained. For example, as discussed above, while a targeted campaign can benefit from analysis with respect to a degenerate distribution, a broad campaign may not. Therefore, if the campaign is known to be a broad campaign based on the campaign mode 710, then the degenerate distribution analysis can be avoided and the existing probability distribution maintained (at block 1208).

If the mode is unknown/unavailable and/or the mode 710 is determined to be a targeted campaign (e.g., focused on a particular age range or subset of age ranges), then, at block 1206, the data distribution is measured. For example, the user age probability distribution is measured to determine a complement or inverse of a dominant, primary, or most likely value in the distribution. According to the Complement Rule, a sum of the probabilities of an event and its complement must equal one. Therefore, the complement of a probability of A (e.g., an age range, etc.) can be represented as:

P(A′)=1−P(A) (Eq. 1).

Referring back to the example distribution 802 in the graph 800 of FIG. 8, the distribution 802 has a single most likely value 810. If there is an 85% probability that the users at the terminal node T1 associated with the example distribution 802 are in the 25-29 age range 808, then the complement of that probability is 15% that the users at T1 are in another age range 808 (e.g., P(A′)=1−0.85=0.15).

Alternatively or in addition, the user age probability distribution can be measured to determine an entropy associated with the distribution. For example, a Shannon entropy or information entropy can be calculated according to the following equation:

H=−Σᵢpᵢ log(pᵢ) (Eq. 2),

where there are n possible age ranges with associated probability (p₁, . . . , pₙ). Entropy is zero when the outcome is certain. Conversely, the more uncertainty in a probability distribution, the greater the entropy of the distribution. For example, the example distribution 802 has less entropy than the example distribution 804 in the example of FIG. 8. Applying Equation 2 to the example distributions of FIG. 8 provides, approximately:

H=−[0.03 log(0.03)+0.85 log(0.85)+0.04 log(0.04)+0.03 log(0.03)]=0.046+0.06+0.056+0.046=0.21,

for the example distribution 802. For the example distribution 804, Equation 2 yields approximately:

H=−[0.388 log(0.388)+0.07 log(0.07)+0.412 log(0.412)+0.06 log(0.06)]=0.16+0.081+0.16+0.073=0.47.

As described above, a measure of information distribution within a probability distribution 802, 804 can be determined at block 1208. An indication of how “peaky” a distribution is impacts how the distribution is processed to improve age determination accuracy for resulting data, for example.

At block 1210, the information generated regarding the data distribution (e.g., an entropy value for the example age probability distributions 802, 804) by the measurement module 702 is compared to a threshold 712 by the comparator 704. As discussed above, the threshold 712 can be calculated to balance targeted accuracy 904 and broad accuracy 906 as in the example of FIG. 9. After determining the threshold 712 based on the score 902, the distribution 802, 804 entropy information is compared to the threshold 712 by the comparator 704 to determine next processing for the example distribution 802, 804.

In certain examples, the threshold 712 is set by testing a campaign targeted at a single age bucket and a broad campaign for various age groups. A first accuracy number 904 is determined for the targeted campaign, and a second accuracy number 906 is determined for the broad campaign. Scores 902 are determined and compared when a degenerate distribution is used for the targeted campaign and the broad campaign. The threshold 712 can be set as a dividing line between forcing the degenerate distribution and maintaining the current probability distribution function when applied to the age distribution information.

In certain examples, the terminal nodes are processed iteratively or recursively in subsets to determine whether a subset of terminal node(s) is appropriately snapped to the degenerate distribution. For example, a subset of terminal nodes closest to a degenerate (e.g., mode) value is processed first (e.g., a smallest distance from the mode or most likely value in the distribution, such as an entropy of 0 with respect to the degenerate distribution). Analysis can proceed to encompass more and more terminal nodes until the threshold 712 is exceeded. In certain examples, the threshold 712 can be dynamically modified based on a number and size of terminal nodes and their average (e.g., simple average, weighted average, etc.) when compared to the degenerate distribution.

For example, using Equation 2 above and the example distribution results from FIG. 8, suppose the accuracy threshold 712 is determined to be 0.25. The entropy of the example distribution 802 is below the threshold 712 of 0.25 at 0.21. The entropy of the example distribution 804 is above the threshold 712 at 0.47.

If the comparison by the comparator 704 determines that the entropy is greater than (or greater than or equal to) the threshold 712, then control shifts to block 1208, at which the probability distribution (e.g., age distribution 804) is maintained. In the example above, the entropy of the example distribution 804 is 0.47, when is greater than the determined distance threshold 712 of 0.25. If the comparison by the comparator 704 determines that the entropy is less than or equal to (or less than) the threshold 712, then control shifts to block 1214 to set the degenerate distribution. In the example above, the entropy of the example distribution 802 is 0.21, which is less than the distance threshold 712 of 0.25.

At block 1214, the distributor 706 adjusts the probability distribution 802 for age of user and replaces the original distribution 802 with a degenerate distribution for the information in distribution 802. For example, the distribution 802 is replaced by the mode or most likely value 810 in the distribution 802. The distribution then becomes a single value (e.g., a single age range) associated with a 100% probability of the user being in that single age range. In contrast, at block 1208, the distributor 706 maintains the original distribution (e.g., example distribution 804) and its included probabilities that the user is of varying age ranges.

Thus, for example, users at terminal node A are almost all at or near an age range of 18-20, so the degenerate distribution is used to set the age range of all users at terminal node A to 18-20. At terminal node B, however, the data distribution is too dispersed (e.g., too peaky or having too much entropy, etc.), so the full distribution is maintained. For example, suppose 50% of users at terminal node B are in an age range of 18-20, 10% are in an age range of 21-24, and 40% are in an age range of 24-34. If forty users are in the group at terminal node B, then twenty users are ages 18-20, four users are ages 21-24, and sixteen users are ages 25-34.

At block 1216, the resulting data is output for usage by a marketing entity, such as the AME 414, a product provider, a service provider, a marketing research entity, etc. For example, a sports broadcaster evaluating which users watched a televised football game receive a report indicating that the broadcast reached twenty people aged 18-20, four people aged 21-24, and sixteen people aged 25-34.

Thus, certain examples provide a more accurate determination of user age, regardless of whether or not a user has been truthful or complete in entering his or her information in a user profile and/or other user registration. Certain examples dynamically update a determined probability distribution and associated information model so that the updated model can be applied to incoming data to increase accuracy in correlating incoming media exposure data with user demographics. Certain examples allow marketers, manufacturers, retailers, resellers, and/or other providers to make better informed decision as to how they tune their sales/marketing models, increase advertising effectiveness, tune to more effectively reach a target audience, etc. Certain examples take into account an advertising campaign mode to more intelligently and automatically determine a best fit for demographic age probability distribution, snapping certain distributions to a single value and avoiding a more dispersed probability distribution when the campaign type and information available justify the single value of the degenerate distribution, rather than the probability distribution function.

FIG. 13 is a block diagram of an example processor platform 1300 capable of executing the instructions of FIGS. 10-12 to implement the example apparatus 500 (and its components) of FIGS. 4-7. The processor platform 1300 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1300 of the illustrated example includes a processor 1312. The processor 1312 of the illustrated example is hardware. For example, the processor 1312 can be implemented by one or more integrated circuits, logic circuits, microprocessors or controllers from any desired family or manufacturer. In the illustrated example, the processor 1312 is structured to include the example measurement module 702, the example comparator 704, and the example distributor 706 of the example demographic data correction module 504.

The processor 1312 of the illustrated example includes a local memory 1313 (e.g., a cache). The processor 1312 of the illustrated example is in communication with a main memory including a volatile memory 1314 and a non-volatile memory 1316 via a bus 1318. The volatile memory 1314 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1316 may be implemented by flash memory and/or any other desired type of memory device. Access to the main memory 1314, 1316 is controlled by a memory controller.

The processor platform 1300 of the illustrated example also includes an interface circuit 1320. The interface circuit 1320 may be implemented by any type of interface standard, such as an Ethernet interface, a universal serial bus (USB), and/or a PCI express interface.

In the illustrated example, one or more input devices 1322 are connected to the interface circuit 1320. The input device(s) 1322 permit(s) a user to enter data and commands into the processor 1312. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1324 are also connected to the interface circuit 1320 of the illustrated example. The output devices 1324 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1320 of the illustrated example, thus, typically includes a graphics driver card, a graphics driver chip or a graphics driver processor.

The interface circuit 1320 of the illustrated example also includes a communication device such as a transmitter, a receiver, a transceiver, a modem and/or network interface card to facilitate exchange of data with external machines (e.g., computing devices of any kind) via a network 1326 (e.g., an Ethernet connection, a digital subscriber line (DSL), a telephone line, coaxial cable, a cellular telephone system, etc.).

The processor platform 1300 of the illustrated example also includes one or more mass storage devices 1328 for storing software and/or data. Examples of such mass storage devices 1328 include floppy disk drives, hard drive disks, compact disk drives, Blu-ray disk drives, RAID systems, and digital versatile disk (DVD) drives.

Coded instructions 1332 representing the flow diagrams of FIGS. 10-12 may be stored in the mass storage device 1328, in the volatile memory 1314, in the non-volatile memory 1316, and/or on a removable tangible computer readable storage medium such as a CD or DVD.

From the foregoing, it will be appreciated that examples have been disclosed which allow people (e.g., panelists, respondents, and/or unidentified/anonymized users, etc.) to be dynamically, automatically analyzed and grouped according to age group/range, which is then processed to improve an accuracy of an associated probability that a given user does in fact fall in the determined age range. In certain cases, rather than utilizing a probability distribution function including a variety of possible values, if a single most likely value exists in the distribution, as evaluated against a threshold, then the probability can be set to 100% at that most likely value (a degenerate distribution at the mode value). The threshold can be dynamically adjusted based on an iterative or recursive evaluation of terminal node information in a user age decision tree to reach a best score that balances both a broad analysis across multiple age groups and a targeted analysis toward a single age group.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus comprising:
interface circuitry;
memory;
instructions; and
processor circuitry to execute the instructions to at least:
evaluate each node of a decision tree with respect to a threshold, the decision tree including a plurality of nodes, each node including a probability distribution of first demographic data;
when the probability distribution of the respective node satisfies the threshold, form an updated node by replacing the probability distribution of the respective node with a single value;
when the probability distribution of the respective node exceeds the threshold, maintain the respective node by maintaining the probability distribution of the respective node, one or more updated nodes and one or more maintained nodes forming an updated decision tree;
adjust the updated decision tree with an adjustment model to form an adjusted decision tree, the adjustment model generated from second demographic data; and
output the adjusted decision tree and the adjustment model via the interface circuitry.

2. The apparatus of claim 1, wherein the processor circuitry is to execute the instructions to:
obtain first data from a first source
obtain second data from a second source, the first data and the second data corresponding to overlapping sets of users;
form a modeling data set from a first portion of the first data and a second portion of the second data corresponding to a same set of users; and
generate the adjustment model using a training data set formed from a subset of the modeling data set.

3. The apparatus of claim 2, wherein the processor circuitry is to generate a plurality of training models, the adjustment model selected from the plurality of training models.

4. The apparatus of claim 1, wherein the first demographic data includes user age data, and wherein each node of the decision tree is associated with one or more users in one or more age ranges according to the respective probability distribution of user age.

5. The apparatus of claim 1, wherein the processor circuitry is to calculate the threshold as a combination of a first score associated with broad accuracy across a plurality of age ranges and a second score associated with targeted accuracy in a single age range.

6. The apparatus of claim 1, wherein the processor circuitry is to determine the threshold based on an entropy associated with the probability distributions of the nodes of the decision tree.

7. The apparatus of claim 1, wherein the processor circuitry is to determine the threshold based on a complement of a highest probability age range in the probability distributions of the nodes of the decision tree.

8. The apparatus of claim 1, wherein the processor circuitry is to evaluate each node of the decision tree with respect to the threshold based on a mode.

9. The apparatus of claim 8, wherein the mode includes a general mode and a targeted mode, and wherein the processor circuitry is to evaluate each node of the decision tree with respect to the threshold when the mode is the targeted mode.

10. At least one computer readable storage medium comprising instructions that, when executed, cause at least one processor to at least:
process each node of a decision tree with respect to a threshold, the decision tree including a plurality of nodes, each node including a probability distribution of first demographic data;
when the probability distribution of the respective node satisfies the threshold, form an updated node by replacing the probability distribution of the respective node with a single value;
when the probability distribution of the respective node exceeds the threshold, maintain the respective node by maintaining the probability distribution of the respective node, one or more updated nodes and one or more maintained nodes forming an updated decision tree;
adjust the updated decision tree with an adjustment model to form an adjusted decision tree, the adjustment model generated from second demographic data; and
deploy the adjusted decision tree and the adjustment model.

11. The least one computer readable storage medium of claim 10, wherein the instructions, when executed, cause the at least one processor to:
obtain first data from a first source
obtain second data from a second source, the first data and the second data corresponding to overlapping sets of users;
form a modeling data set from a first portion of the first data and a second portion of the second data corresponding to a same set of users; and
generate the adjustment model using a training data set formed from a subset of the modeling data set.

12. The least one computer readable storage medium of claim 10, wherein the instructions, when executed, cause the at least one processor to calculate the threshold as a combination of a first score associated with broad accuracy across a plurality of age ranges and a second score associated with targeted accuracy in a single age range.

13. The least one computer readable storage medium of claim 10, wherein the instructions, when executed, cause the at least one processor to determine the threshold based on an entropy associated with the probability distributions of the nodes of the decision tree.

14. The least one computer readable storage medium of claim 10, wherein the instructions, when executed, cause the at least one processor to determine the threshold based on a complement of a highest probability age range in the probability distributions of the nodes of the decision tree.

15. The least one computer readable storage medium of claim 10, wherein the instructions, when executed, cause the at least one processor to evaluate each node of the decision tree with respect to the threshold when the at least one processor is operating in a targeted mode.

16. A system comprising:
means for comparing each node of a decision tree with respect to a threshold, the decision tree including a plurality of nodes, each node including a probability distribution of first demographic data, wherein, when the probability distribution of the respective node satisfies the threshold, the means for comparing is to form an updated node by replacing the probability distribution of the respective node with a single value, and, when the probability distribution of the respective node exceeds the threshold, the means for comparing is to maintain the respective node by maintaining the probability distribution of the respective node, one or more updated nodes and one or more maintained nodes forming an updated decision tree;
means for adjusting the updated decision tree with an adjustment model to form an adjusted decision tree, the adjustment model generated from second demographic data; and
means for generating the adjusted decision tree and the adjustment model.

17. The system of claim 16, further including:
means for measuring to:
obtain first data from a first source
obtain second data from a second source, the first data and the second data corresponding to overlapping sets of users; and
form a modeling data set from a first portion of the first data and a second portion of the second data corresponding to a same set of users,
wherein the means for adjusting is to generate the adjustment model using a training data set formed from a subset of the modeling data set.

18. The system of claim 16, wherein the means for comparing is to calculate the threshold as a combination of a first score associated with broad accuracy across a plurality of age ranges and a second score associated with targeted accuracy in a single age range.

19. The system of claim 18, wherein the means for comparing is to determine the threshold based on an entropy associated with the probability distributions of the nodes of the decision tree.

20. A method comprising:
processing, by executing an instruction with a processor, each node of a decision tree with respect to a threshold, the decision tree including a plurality of nodes, each node including a probability distribution of first demographic data;
when the probability distribution of the respective node satisfies the threshold, forming, by executing an instruction with the processor, an updated node by replacing the probability distribution of the respective node with a single value;
when the probability distribution of the respective node exceeds the threshold, maintaining, by executing an instruction with the processor, the respective node by maintaining the probability distribution of the respective node, one or more updated nodes and one or more maintained nodes forming an updated decision tree;
adjusting, by executing an instruction with the processor, the updated decision tree with an adjustment model to form an adjusted decision tree, the adjustment model generated from second demographic data; and
deploying, by executing an instruction with the processor, the adjusted decision tree and the adjustment model.
